(19) United States
(12) Patent Application Publication
(10) Pub. No.: US 2026/0189378 A1
(43) Pub. Date: Jul. 2, 2026

(54) DYNAMIC NETWORK ANALYSIS AND INTERACTIVITY USING ENCRYPTION WITH A LARGE LANGUAGE MODEL

(71) Applicant: Insight Direct USA, Inc., Chandler, AZ (US)

(72) Inventor: Joshua Spiers, Renton, WA (US)

(21) Appl. No.: 19/043,686

(22) Filed: Feb. 3, 2025

Related U.S. Application Data
(60) Provisional application No. 63/549,022, filed on Feb. 2, 2024.

(51) Int. Cl. H04L 9/08; H04L 41/12; H04L 41/16

(52) U.S. Cl. CPC H04L 9/0861; H04L 41/12; H04L 41/16

(57) ABSTRACT

A method for determining a natural language output regarding a digital network using encryption with a large language model (“LLM”) can include receiving unencrypted information that includes a desired output dependent upon the digital network; identifying words that are to be encrypted; generating a corresponding key for each word; replacing each instance of the words in the unencrypted information; generating an encrypted query dependent upon first encrypted information; receiving, from the LLM, the encrypted query as requested by the query prompt; replacing each instance of the keys in the encrypted query with the corresponding words; determining an unencrypted response to the unencrypted query with a graph database being representative of at least a portion of the digital network; forming an encrypted query response; generating an encrypted natural language output dependent upon a second encrypted information; receiving, the encrypted natural language output; and forming an unencrypted natural language output.

### CROSS-REFERENCE TO RELATED APPLICATIONS

This application is a nonprovisional application claiming the benefit of U.S. provisional application Ser. No. 63/549,029, filed on Feb. 2, 2024, and entitled “ENHANCED ENCRYPTION WITH REFERENTIAL INTEGRITY FOR USE WITH A LARGE LANGUAGE MODEL” by Joshua Spiers. Further, this application is a nonprovisional application claiming the benefit of U.S. provisional application Ser. No. 63/549,022, filed on Feb. 2, 2024, and entitled “DYNAMIC NETWORK MAPPING AND INTERACTIVITY USING A LARGE LANGUAGE MODEL” by Joshua Spiers.

### FIELD OF THE INVENTION

The disclosure relates generally to digital networks and, more particularly, to using a large language model to interact with and/or assist in analyzing, evaluating, and graphing the digital network. Further, the disclosure relates generally to digital encryption and, more particularly, to encryption using format preservation and/or referential integrity configured to be used in providing data/information to and receiving data/information from a large language model.

### BACKGROUND

A digital network, also referred to as a computer network, can be a group of computers and/or other devices that are connected in order to communicate and share resources. Digital networks can be and/or include local area networks (LANs), wide area networks (WANs), and/or other area networks, devices, configurations, and forms of communication. For example, the digital network can use ethernet, Wi-Fi, Bluetooth, internet protocol domain name system(s), and/or other networking technologies.

Digital networks can include any number of devices. For example, a digital network for a large company can include tens of thousands of interconnected devices. While digital networks can provide for the communication of information and sharing of resources across many devices, the large and complex interconnectedness of devices on a digital network can cause and/or experience issues that prevent this exchange of information and sharing of resources for one, multiple, or all devices on the digital network. Remedying these issues can be difficult and time consuming because the problem may not be easily discernable due to the size/extent of the digital network and the potential need to access and/or review each device.

Additionally, the information on and/or associated with a digital network can be sensitive such that protection of this information from outside sources may be desired. Often times, encryptions may be used. However, standard encryption replaces words, phrases, numerical values, etc. in a way that is difficult for the encrypted information to be used by a large language model.

### SUMMARY

A first example method of encrypting information provided to a large language model is disclosed herein that can include receiving first unencrypted information, identifying a first word within the first unencrypted information that is to be encrypted, replacing the first word within the first unencrypted information with an automatically generated first key to create first encrypted information, automatically replacing all instances of the first word with the first key to maintain referential integrity amongst the first word and the first encrypted information, saving the first word and the associated first key in a first word-key pair database, and providing the first encrypted information to the large language model along with a first prompt requesting that the large language model generate a first encrypted output dependent upon the first encrypted information. The example method can further include receiving, from the large language model, the first encrypted output dependent upon the first encrypted information and replacing, using the first word-key pair database, all instances of the first key with the first word to create a first unencrypted output.

A second example method of encrypting information provided to a large language model is disclosed herein that can include receiving unencrypted information; identifying at least one word to be encrypted; for each word of the at least one word to be encrypted, automatically generating a corresponding key; replacing each word of the at least one word to be encrypted with the corresponding key to form encrypted information, wherein each key maintains a similar format as each corresponding word to preserve the format of the word so that the encrypted information maintains a similar context to the unencrypted information; saving each different word that is encrypted and each corresponding key in a word-key pair database; providing the encrypted information and a prompt to the large language model; receiving, from the large language model, an encrypted output dependent upon the encrypted information; and replacing each key corresponding to each word of the at least one word in the encrypted output to form an unencrypted output.

A first example system for encrypting information for use with a large language model is disclosed herein that can include unencrypted information that can include at least one word to be encrypted; an identification module configured to identify the at least one word to be encrypted in the unencrypted information; a key generation module configured to generate at least one key corresponding to the at least one word to be encrypted in the unencrypted information, the at least one key having a similar format as the corresponding at least one word so that the key preserves the format of the corresponding word to maintain a similar context; a word-key pair database that includes the at least one word to be encrypted and the corresponding at least one key; a replacement module configured to replace the at least one word with the corresponding at least one key, wherein the replacement module replaces all instances of the at least one word with the corresponding at least one key to form encrypted information; a prompt module configured to determine a prompt to the large language model requesting the large language model to determine an encrypted output based upon the encrypted information; and wherein, in response to the reception of the encrypted output from the large language model, the replacement module is configured to replace the at least one key with the corresponding at least one word to form an unencrypted output.

A second example system for encrypting information for use with a large language model is disclosed herein that can include an identification module configured to identify, in unencrypted information, a word to be encrypted; a key generation module configured to generate a key corresponding to the word to be encrypted in the unencrypted information; a replacement module configured to replace all instances of the word with the corresponding key to form encrypted information, the replacement module replacing all instances of the word in the unencrypted information with the same corresponding key to maintain referential integrity amongst the newly formed encrypted information; and a prompt module configured to generate a prompt to the large language model requesting the large language model to generate an encrypted output based upon the encrypted information that includes the key, wherein, in response to the reception of the encrypted output from the large language model, the replacement module is configured to unencrypt the encrypted output to form an unencrypted output by replacing all instances of the key in the encrypted output with the corresponding word.

A third example method of determining a natural language output regarding a digital network using a large language model is disclosed herein that can include formulating a desired output dependent upon information associated with the digital network; providing, to the large language model, the information associated with the digital network and a first prompt requesting the large language model to generate a query dependent upon the information and the desired output; receiving, from the large language model, the query dependent upon the information and the desired output; determining, dependent upon a graph database, a response to the query with the graph database being representative of at least a portion of the digital network; providing, to the large language model, the response and a second prompt requesting the large language model to generate the natural language output dependent upon the response; and receiving, from the large language model, the natural language output dependent upon the response and associated with the digital network.

A third example system for determining a natural language output regarding a digital network using a large language model is disclosed herein that can include a computer processor configured to receive a desired output dependent upon information associated with the digital network; a prompt module configured to determine a query prompt to the large language model requesting the large language model to generate a query dependent upon the information and the desired output; and a graph database management system configured to determine, dependent upon a graph database representative of at least a portion of the digital network, a response to the query as received from the large language model, wherein the prompt module is also configured to determine an output prompt to the large language model requesting the large language model to generate the natural language output dependent upon the response to the query, and wherein the large language model generates the natural language output as requested in the output prompt.

A fourth example system for determining a natural language output regarding a digital network is disclosed herein that can include a computer processor configured to receive a desired output as selected by a user, the desired output being dependent upon information associated with the digital network; a prompt module in communication with the computer processor and configured to generate a query prompt to a large language model; the large language model configured to generate a query dependent upon the information and the query prompt; a graph database management system configured to determine, dependent upon a graph database representative of at least a portion of the digital network, a response to the query as generated by the large language model, wherein the prompt module is configured to generate an output prompt dependent upon the response to the query, and wherein the large language model, in response to the output prompt, generates a natural language output dependent upon the response to the query as determined by the graph database management system.

A fourth example method for determining a natural language output regarding a digital network using encryption with a large language model is disclosed herein that can include receiving unencrypted information that includes a desired output dependent upon the digital network; identifying at least one word within the unencrypted information that is to be encrypted; generating a corresponding key for each word of the at least one word to be encrypted; replacing each instance of the at least one word in the unencrypted information with the corresponding key to form first encrypted information; providing, to the large language model, the first encrypted information that is associated with the digital network and a query prompt requesting the large language model to generate an encrypted query dependent upon the first encrypted information; receiving, from the large language model, the encrypted query as requested by the query prompt and dependent upon the first encrypted information; replacing each instance of the at least one key in the encrypted query with the corresponding word of the at least one word to form an unencrypted query; determining, dependent upon a graph database, an unencrypted response to the unencrypted query with the graph database being representative of at least a portion of the digital network; replacing each instance of the at least one word in the unencrypted response with the corresponding key to form an encrypted query response; providing, to the large language model, second encrypted information dependent upon the encrypted query response and an output prompt requesting the large language model to generate an encrypted natural language output dependent upon the second encrypted information; receiving, from the large language model, the encrypted natural language as requested by the output prompt and dependent upon the second encrypted information; and replacing each instance of the at least one key in the encrypted natural language output with the corresponding key to form an unencrypted natural language output regarding the digital network.

A fifth system for determining a natural language output regarding a digital network using encryption with a large language model is disclosed herein that can include an identification module configured to identify, in unencrypted information that includes a desired output associated with the digital network, at least one word to be encrypted; a key generation module configured to generate a key corresponding to each word of the at least one word to be encrypted; a replacement module configured to replace all instances of each word of the at least one word to be encrypted with each corresponding key to form first encrypted information; a prompt module configured to generate a query prompt requesting the large language model to generate an encrypted query dependent upon the first encrypted information, wherein the encrypted query is unencrypted by the replacement module to form an unencrypted query; a graph database management system configured to determine, dependent upon a graph database representative of the digital network, an unencrypted query response based upon the unencrypted query, wherein the prompt module is configured to generate an output prompt requesting the large language model to generate an encrypted natural language output dependent upon second encrypted information based upon the unencrypted query response and encrypted by the replacement module, and wherein the replacement module is configured to unencrypted the encrypted natural language output as received from the large language model to form an unencrypted natural language output associated with the digital network.

### BRIEF DESCRIPTION OF THE DRAWINGS

FIG. 1 is a block schematic diagram of an example encryption system for use with a large language model.

FIG. 2 is an example table showing unencrypted information, information using prior art encryption, and encrypted information having format preservation.

FIG. 3 is a block schematic diagram of an example network analysis system functioning in conjunction with and/or including a large language model.

FIG. 4 is a method flow chart describing an example process for encrypting information for use with a large language model to analyze a network via a representative graph database.

While the above-identified figures set forth one or more examples of the present disclosure, other examples/embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

Systems and related processes are disclosed herein for encrypting information for use with a large language model (hereinafter also referred to as an “LLM”) as well as using a large language model to interact with and/or assist in analyzing and evaluating a digital network (hereinafter also referred to just as a “network”) via a representative graph database. The disclosed systems and processes have many advantages. First, the systems and processes ensure that any sensitive information, such as information dependent upon a graph database representative of a network and/or information from the network itself, is encrypted before that sensitive information is provided to an LLM. Second, while encrypting that sensitive information, the systems and processes ensure that the information retains referential integrity, meaning that the same (and similar variations of the) word to be encrypted (with “word” being described below broadly) is replaced by the same key for every instance that the word appears (and is replaced) in the sensitive information. This capability is advantageous when using an LLM because it ensures the LLM can draw conclusions and respond consistently as the encrypted information provided to the LLM is consistent (i.e., has consistent wording because one key is used when replacing the same word multiple times). Third, while encrypting that sensitive information, the systems and processes ensure that the key replacing the word to be encrypted maintains/preserves the format of the word. For example, if the word to be encrypted is an Internet Protocol (IP) address, the key replacing that word will have the format of an IP address. This capability is advantageous when using an LLM because it ensures the LLM understands what the encrypted word (as is represented by the key) is/represents, which may be useful to the LLM in responding to any prompts including that word/key because the LLM can accurately make inferences and draw conclusions. Fourth, the systems and processes ensure that only the information required for the LLM to respond to a prompt is provided to the LLM with most or all of the potentially sensitive information (e.g., the graph database representative of the digital network) being stored/controlled by the user and/or at a location distant from the LLM.

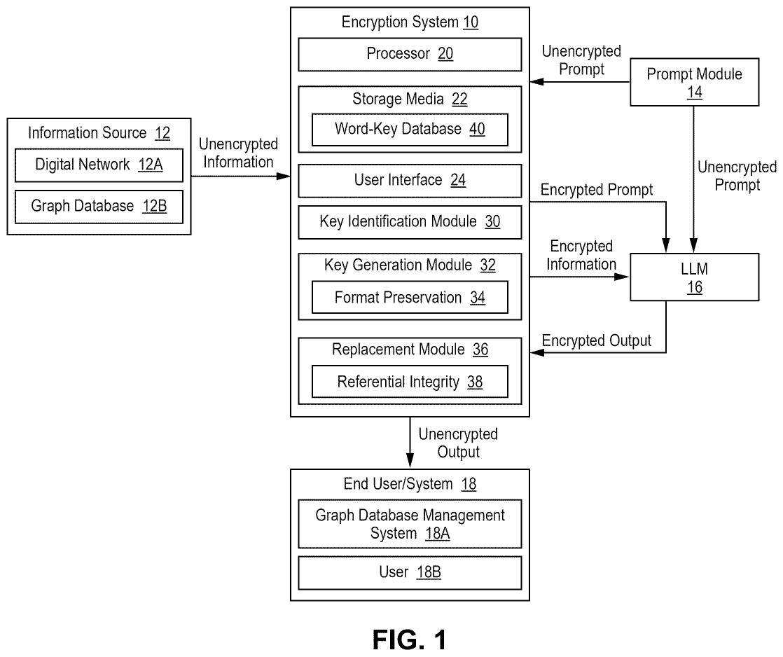

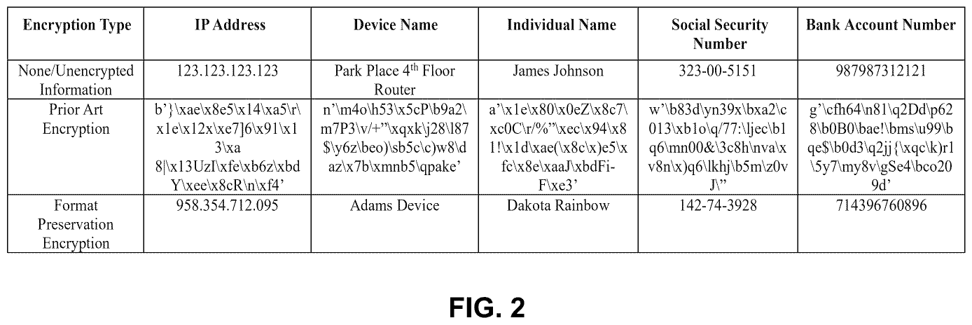

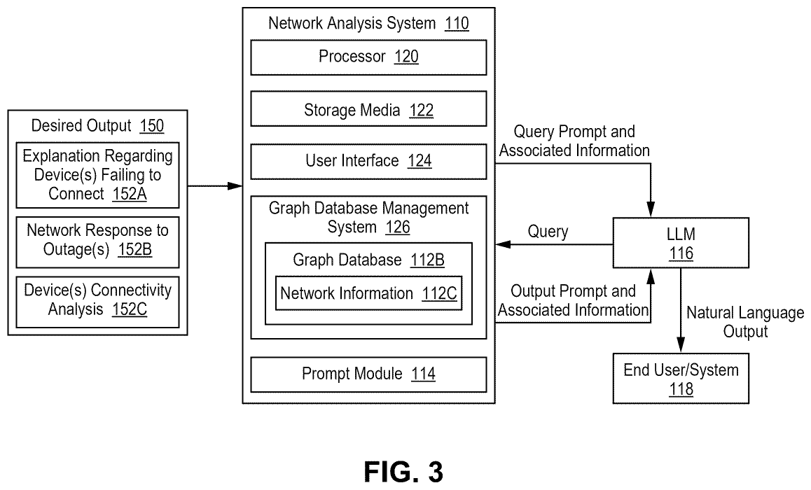

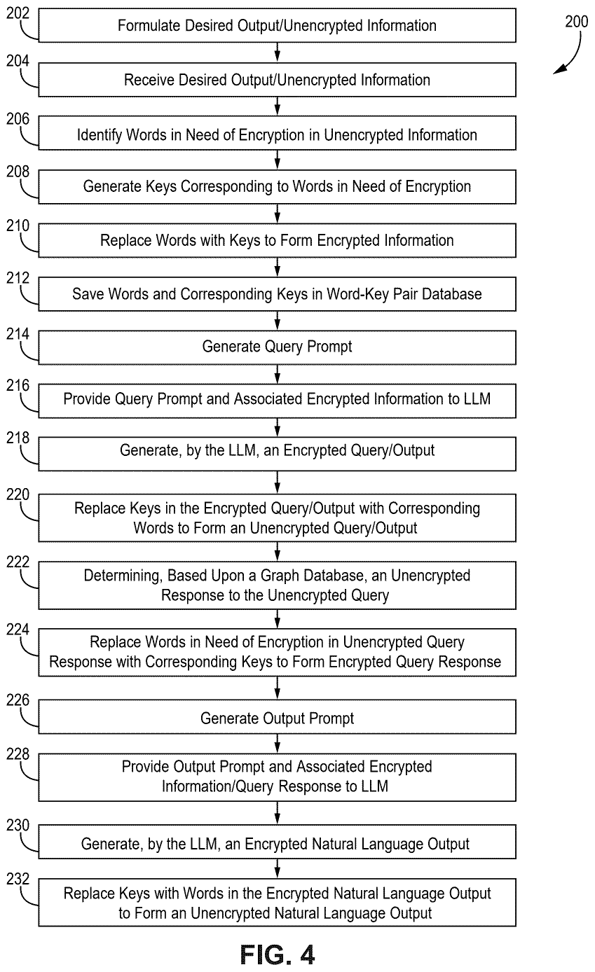

An LLM is only as useful as the information provided to the LLM, and the disclosed systems and processes ensure that the information provided to the LLM (along with a prompt) is accurate and consistent while also allowing for that information to be encrypted to protect the sensitivity of that information. Additionally, the systems and processes ensure that only the necessary information is provided to the LLM, thus maintaining control (by the user) of as much of the sensitive, unencrypted information as possible while also allowing for the LLM to provide inferences and/or conclusions associated with the sensitive information. These and other features, functions, capabilities, and/or advantages of the disclosed systems and processes are realized by reviewing the below disclosure. The following first describes the encryption system with reference to FIGS. 1 and 2. Then, the network analysis system is described with reference to FIG. 3. Finally, a process that includes both elements/steps from the encryption system and the network analysis system is described with reference to FIG. 4.

FIG. 1 is a block schematic diagram of example encryption system 10 (hereinafter also referred to as just “system 10”) for use with LLM 16. System 10 can be in communication with, use, and/or include information source 12, prompt module 14, and end user/system 18. Encryption system 10 can include, among other components not expressly disclosed herein, processor 20, storage media 22, user interface 24, key identification module 30, key generation module 32 having format preservation 34, replacement module 36 having referential integrity 38, and word-key pair database 40, which can be located within storage media 22. Information source 12 can generate, provide, and/or allow access to unencrypted information, which can be from and/or associated with digital network 12A and/or graph database 12B. Prompt module 14 can generate, provide, and/or allow access to one or multiple prompts. Prompt module 14 can be a stand-alone system or can be, for example, a sub-component of a larger system, such as network analysis system 110 as shown in FIG. 3, and/or can be in communication with one or both of encryption system 10 and/or LLM 16. End user/system 18 can be any user, system, location, etc. to which the unencrypted output is provided and/or allowed access, such as graph database management system 18A (e.g., as shown in FIG. 3 as a sub-component of network analysis system 110) and/or user 18B. In another configuration/example, one, multiple, and/or all of information source 12, prompt module 14, LLM 16, and/or end user/system 18 are components within and/or otherwise associated with system 10. Any of the systems/components shown in FIG. 1 can communicate via the internet and/or other communication methods, such as wired and/or wireless communication.

FIG. 1 focuses on hardware components of encryption system 10. FIG. 1 is provided as illustrative examples of a general hardware system for performing the capabilities discussed herein. The components presented in FIG. 1, particularly including modules 14, 30, 32, and/or 36 (and associated components) can be omitted or replaced with analogous hardware and/or software in different architectures without departing from the scope and spirit of the present disclosure.

Encryption system 10 (and network analysis system 110 described with regards to FIG. 3 and process 200 described with regards to FIG. 4) can include other steps, components, modules, configurations, and/or features not expressly disclosed herein that are suitable for generating encrypted outputs, unencrypted outputs, queries, and/or natural language outputs, among other capabilities. For example, systems 10 and/or 110 can include any number of digital/electronic storage media (e.g., storage media 22 and/or 122) for storing data, information, and/or executable instructions. Systems 10 and/or 110 can include any number of computer processors (e.g., processor 20 and/or 120) for performing tasks/instructions with regards to system 10, system 110, and/or process 200. Further, systems 10 and/or 110 can allow for communication via wired or wireless communication methods between components of systems 10 and/or 110 and/or between other components, systems, individuals/users, etc. distant from systems 10 and/or 110. Systems 10 and/or 110 is described herein as including one or multiple “modules,” which can be any hardware and/or software for performing the tasks, functionality, and/or capabilities described herein. These “modules” can be instantiated in dedicated hardware and/or software, and/or can be defined functionally and use shared hardware and/or software.

Additionally, systems 10 and/or 110 can be a discrete assembly or be formed by one or more components capable of individually or collectively implementing the functionalities described herein. In some examples, systems 10 and/or 110 can be implemented as a plurality of discrete circuitry subassemblies. In some examples, one, multiple, or all components of systems 10 and/or 110 can include and/or be implemented at least in part on a smartphone or tablet, among other options. In some examples, one, multiple, or all components of systems 10 and/or 110 can include and/or be implemented as downloadable software in the form of a mobile application. The mobile application can be implemented on a computing device, such as a personal computer, tablet, or smartphone, among other suitable devices. One, multiple, or all components of systems 10 and/or 110 can be considered to form a single computing device even when distributed across multiple component computing devices. Systems 10 and/or 110 can include a configuration in which one, multiple, or all of the functions described herein are performed by different components. Systems 10 and/or 110 can include various components for performing the above functions (as well as other functions described in this disclosure), such as processor 20 and/or 120, storage media 22 and/or 122, and/or user interface 24 and/or 124.

Encryption system 10 can access, receive, and/or otherwise use unencrypted information, which can be collected/determined from/by information source 12. Information source 12 can be and/or use any components, system, etc., such as (as shown in FIG. 1) digital network 12A and/or graph database 12B, which can be dependent upon digital network 12A. Digital network 12A can be a digital network having any number of devices that are connected in order to communicate and/or share resources. For example, digital network 12A can be for a large company and can include tens of thousands of devices. Each device on digital network 12A can have any characteristics and/or properties either inherent to each device (e.g., the device type) and/or listed in information associated with each device (e.g., interface descriptions). Device information can include, for example, a device availability, a device state, a pool name of the device, and/or an IP address of the device. Device information and/or interface descriptions for each device can be, for example, comments entered by the user/technician who set up and/or otherwise has access to the device and/or the configurations of the device. The devices in digital network 12A can be any type of element, component, module, and/or electronic system/apparatus, such as a router, a hub, a modem, a repeater, a switch, a bridge, an access point, a gateway, a firewall, a network interface card, an intrusion detection system, an intrusion prevention system, a virtual private network, network attached storage, and/or a load balancer. Digital network 12A can have any number of each of the above listed types of devices and/or other types of devices.

Some or all of the information associated with digital network 12A (and/or other information) can be represented in graph database 12B. Graph database 12B can be representative of at least a portion of digital network 12A and can include information regarding one, multiple, and/or all devices, connections/connectivity, interface descriptions, and/or any other information regarding digital network 12A. Graph database 12B can be in a usual format for a graph database that is known to one of skill in the industry and is acceptable by programs, systems, etc. familiar with accepting/accessing information in a graph database. Graph database 12B can be representative of the current state of digital network 12A, a previous state of digital network 12A, and/or a desired state of digital network 12A. Graph database 12B can include other information, have other formats, and/or otherwise be a source of unencrypted information in other ways than those described herein. Digital network 12A and graph database 12B are merely examples of information source 12 for providing unencrypted information, and unencrypted information can be accessed, received, and/or otherwise used from other sources not expressly disclosed herein. Additionally and/or alternatively, the unencrypted information can include and/or be in regards to other systems different from digital network 12A (and/or any other digital networks) for which outputs as determined by LLM 16 are desired.

System 10 (and/or the components of system 10) can include one or multiple computer/data processors 20 (also referred to herein as “processor 20”). In general, processor 20 can include any or more than one of a processor, a microprocessor, a controller, a digital signal processor (DSP), an application specific integrated circuit (ASIC), a field-programmable gate array (FPGA), or other equivalent discrete or integrated logic circuitry. Processor 20 can perform instructions stored within storage media 22 (or located elsewhere), and/or processor 20 can include memory such that processor 20 is able to store instructions and perform the functions described herein. Additionally, processor 20 can perform other computing processes described herein, such as the functions performed by any of the components of system 10 and/or any other systems/components shown in FIG. 1.

System 10 (and/or the components of system 10) can also include storage media 22. Storage media 22 is configured to store information (such as word-key pair database 40) and, in some examples, can be described as a computer-readable storage medium, media, and/or memory. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, storage media 22 is a temporary memory. As used herein, a temporary memory refers to a memory having a primary purpose that is not long-term storage. Storage media 22, in some examples, is described as volatile memory. As used herein, a volatile memory refers to a memory that that the memory does not maintain stored contents when power to storage media 22 is turned off. Examples of volatile memories can include random access memories (RAM), dynamic random access memories (DRAM), static random access memories (SRAM), and other forms of volatile memories. In some examples, the storage media/memory is used to store program instructions for execution by the processor. The memory, in one example, is used by software or applications running on system 10 to temporarily store information during program execution.

Storage media 22 can be configured to store larger amounts of information than volatile memory. Storage media 22 can further be configured for long-term storage of information. In some examples, storage media 22 includes non-volatile storage elements. Examples of such non-volatile storage elements can include, for example, magnetic hard discs, optical discs, floppy discs, flash memories, cloud storage media, or forms of electrically programmable memories (EPROM) or electrically erasable and programmable (EEPROM) memories. Additionally, storage media 22 can be digital/electronic storage in the “cloud” that is distant from the other components of system 10.

System 10 can also include user interface 24. User interface 24 can be an input and/or output device and enables an operator/user to control operation, modification, view of data, etc. of the unencrypted information, unencrypted prompts, encrypted information, encrypted prompts, encrypted outputs, unencrypted outputs, word-key pair database 40, and/or the other information and/or systems/components within system 10 and/or in communication with system 10. For example, user interface 24 can be configured to receive inputs, such as unencrypted information and/or unencrypted prompts, from a user and/or provide unencrypted outputs. User interface 24 can include one or more of a sound card, a video graphics card, a speaker, a display device (e.g., a liquid crystal display (LCD), a light emitting diode (LED) display, an organic light emitting diode (OLED) display, etc.), a touchscreen, a keyboard, a mouse, a joystick, and/or other type of device for facilitating input and/or output of information in a form understandable to users and/or machines. In one example, a user, operator, and/or other individual can use user interface 24 to view and/or alter and of the information, prompts, outputs, words to be encrypted, and/or keys associated with system 10.

System 10 is configured to accept, receive, and/or otherwise use unencrypted information (from information source 12) and unencrypted prompts (from prompt module 14) to encrypt one or all of the information/prompts and provide, allow access to, and/or otherwise allow encrypted information and/or encrypted prompts for use by LLM 16. LLM 16 can then, from the encrypted information and/or encrypted (or unencrypted) prompts, generate one or multiple encrypted outputs. System 10 can then be configured to accept, receive, and/or otherwise use encrypted outputs to unencrypt the outputs to form unencrypted outputs. The unencrypted outputs can then be provided to and/or allow access to end user/system 18 for review, evaluation, alteration, and/or any other use. Encryption system 10 is configured to ensure the encrypted information and/or encrypted prompts have at least two advantageous characteristics that allow for LLM 16 to more accurately and completely draw inferences and determine the encrypted outputs from the encrypted information and/or encrypted prompts, such as format preservation and referential integrity. Encryption system 10 is configured, via key generation module 32 (having format preservation 34), to replace any words to be encrypted (as identified by identification module 30) with keys that have a similar format to the corresponding word that is being replaced. An example of format preservation encryption is shown in FIG. 2 (as is described in greater detail below). Additionally, encryption system 10 is configured, via replacement module 36 (having referential integrity 38), to replace the same word in need of encryption (as identified by identification module 30) with the same key such that multiple instances of the same word in need of encryption in the unencrypted information and/or unencrypted prompts are replaced with the same key to form corresponding encrypted information and/or encrypted prompts. Thus, LLM 16 can identify the context in which the keys are used in the encrypted information and/or encrypted prompts as well as draw inferences and/or conclusions from the multiple uses of the same keys to form more accurate and complete encrypted outputs. The individual components of system 10 are described in greater detail below with regards to the example set out in FIG. 1.

System 10 can include and/or work in conjunction with identification module 30. Identification module 30 can include and/or function in conjunction with any of the other components of system 10 (such as processor 20, storage media 22, and/or user interface 24). Identification module 30 can access, receive, and/or otherwise use unencrypted information and/or unencrypted prompts. Identification module 30 can be configured to identify/determine the information to be encrypted. The information, referred to as “words” in this disclosure even though the information in need of encryption can include information other than just words, can be anything that is desired to be protected from disclosure to, for example, LLM 16. For example, the “words” can include, among others: phrases, proper nouns, numerical values, personally identifiable information, protected health information, financial records, human-resource data, commercial information, legal information, controlled unclassified information, and/or any other information having any style and/or configuration of letters, numbers, characters, and/or spaces. Identification module 30 can include and/or work in conjunction with any models, systems, software, etc., such as name recognition artificial intelligence software, that is able to identify the words/information to be encrypted. Furthermore, identification module 30 can be configured to generate and/or add words/information to word-key pair database 40. In one example, identification module 30 generates a word side/column and adds words in need of encryption to the word side/column in word-key pair database 40. In another example, word-key pair database 40 is already generated and identification module 30 is configured to add to and/or otherwise substitute words in word-key pair database 40. Identification module 30 can be configured to manually identify/determine words/information in need of encryption (in unencrypted information and/or unencrypted prompts) as performed by and/or initiated by a user/operator. In some examples, identification module 30 can be configured to automatically identify/determine words/information in need of encryption in response to, for example, the reception of unencrypted information, unencrypted prompts, and/or in response to any other triggering events/instructions. Identification module 30 can be, for example, in communication with storage media 22 to access and/or receive information, such as word-key pair database 40 or information included within word-key pair database 40.

System 10 can include and/or work in conjunction with key generation module 32, which can have/ensure format preservation 34 when determining the key that corresponds to each word/information in need of encryption. Key generation module 32 can access, receive, and/or otherwise use unencrypted information, unencrypted prompts, and/or the words to be encrypted as identified/determined by identification module 30 (as well as any other information from identification module 30 and/or other components). Key generation module 32 can be configured to generate/formulate a key for each different word in the unencrypted information and/or unencrypted prompts that to be encrypted as identified by identification module 30, for example. Key generation module 32, having format preservation 34, can be configured to evaluate a format of the specific word and generate a key that has a similar format to that corresponding word. The key as generated by key generation module 32 for each word in need of encryption can be randomized and be any combination of characters. Thus, the key can have a million or more possibilities to prevent the unauthorized unencryption of the word. Key generation module 32 (and/or system 10 generally) can thus be configured to select a key for each word in need of encryption from one of millions of possibilities (or more). Key generation module 32 can perform the selection/generation of the keys for multiple words (as many words in the unencrypted information as desired, which can be hundreds or thousands of words) simultaneously in a very short amount of time, such as within seconds of key generation module 32 beginning the encryption process.

This format preservation capability is shown in FIG. 2, which is an example table showing unencrypted information, information using prior art encryption, and encrypted information having format preservation. As shown in FIG. 2, the “word” in need of encryption can be, for example, an IP address, a device name in digital network 12A and/or set out in graph database 12B, an individual person's name, a social security number, and/or a bank account (among other information). Standard, prior art encryption can generate a key for each “word” that is independent of the format/type of each “word.” As shown in FIG. 2, the keys using prior art encryption are long combinations of numbers, letters, and other characters that have no connection to the words to which the keys correspond. The prior art encryption can generate keys that are substantially longer and have characters that are not present in the corresponding word. Such a configuration is not advantageous if the key is to be used along with LLM 16 because LLM 16 would have difficulty determining the context of the key that was generated using prior art encryption, drawings inferences, and determining outputs based upon the keys and/or the context of the keys. Thus, format preservation 34 as utilized by key generation module 32 is advantageous when encryption is used along with LLM 16. As shown in FIG. 2, key generation module 32 using format preservation 34 is configured to evaluate the “words” in need of encryption and generate a corresponding key that has a similar format. For example, the IP address as encrypted using format preservation maintains the format of the unencrypted IP address by using a key that includes only numbers and having the same configuration of four sets of three numbers separated by periods. Similarly, for example, the device name as encrypted using format preservation 34 maintains the format of the unencrypted device name by using a key that includes a generated name for the device while understanding that the number of characters in the key is unimportant and that the context of the key being a device name is important. This format preservation is similarly shown with regards to individual name, social security number, and bank account number in example FIG. 2. While format preservation 34 is shown in FIG. 2 with five examples, format preservation 34 can be used with any “words” in need of encryption regardless of whether those words include letters, numbers, characters, spaces, etc.

Key generation module 32 having format preservation 34 can include and/or work in conjunction with any models, systems, software, etc., such as a machine learning model and/or a generative artificial intelligence model, that is able to evaluate and/or generate keys having a similar format to the corresponding words in need of encryption. Furthermore, key generation module 32 can be configured to generate and/or add keys to word-key pair database 40. In one example, key generation module 32 generates a key side/column and adds keys (that correspond to words to be encrypted) to the key side/column in word-key pair database 40. In another example, word-key pair database 40 is already generated with words to be encrypted already present in word-key pair database 40 and key generation module 32 is configured to add to and/or otherwise substitute keys in word-key pair database 40. Key generation module 32 can be configured to manually evaluate words to be encrypted (i.e., the format, type, etc. of the words to be encrypted) and generate keys corresponding to the words to be encrypted as performed by and/or initiated by a user/operator. Additionally and/or alternatively, key generation module 32 can be configured to automatically evaluate words to be encrypted and/or generate keys corresponding to the words to be encrypted in response to, for example, the reception of word(s) to be encrypted (and/or the reception of word-key pair database 40) and/or the addition of word(s) to be encrypted to word-key pair database 40. The automatic evaluation and/or generation can be, for example, in response to any other triggering events/instructions. Key generation module 32 can be, for example, in communication with storage media 22 to access and/or receive information, such as word-key pair database 40.

System 10 can include and/or work in conjunction with replacement module 36, which can have/ensure referential integrity 38 when replacing the words to be encrypted (as determined by identification module 32) with corresponding keys (as generated/determined by key generation module 32). Replacement module 36 can access, receive, and/or otherwise use unencrypted information, unencrypted prompts, the words to be encrypted, the keys corresponding to the words to be encrypted, and/or word-key pair database 40. Replacement module 36 can be configured to replace/substitute one, multiple, or all words to be encrypted in unencrypted information and/or the unencrypted prompts with the corresponding key(s) as generated by key generation module 34, for example. Replacement module 36 having referential integrity 38 can be configured to replace all instances of the same word as it appears in the unencrypted information and the unencrypted prompts with the same key corresponding to that word.

For example, the individual name “James Johnson,” which appears in both the unencrypted information and the unencrypted prompt, can be identified by identification module 30 as being a word to be encrypted. Key generation module 32, using format preservation, can generate the key “Dakota Rainbow” corresponding to the word to be encrypted, “James Johnson.” Replacement module 36 can evaluate one or both of the unencrypted information and the unencrypted prompt for the presence of “James Johnson” and replace all instances of “James Johnson” in the unencrypted information and/or the unencrypted prompt with the corresponding key, which is “Dakota Rainbow.” Since all instances of the word to be encrypted, “James Johnson,” is replaced by the same corresponding key, “Dakota Rainbow,” the information (now herein referred to as “encrypted information”) and the prompt (now herein referred to as an “encrypted prompt”) maintain referential integrity because all reference to “Dakota Rainbow” in the encrypted information and/or the encrypted prompt corresponds to the one unencrypted word, “James Johnson.”

Prior art encryption does not maintain referential integrity and instead provides a different key for each word to be encrypted, even if the word is repeated within the unencrypted information/document. For example, the individual name “James Johnson,” which appears in both the unencrypted information and the unencrypted prompt, is intended to be encrypted. For the first instance, the prior art encryption would replace the word “James Johnson” with, for example, the long combination of numbers, letters, and other characters that have no connection to the words that form “James Johnson,” which is shown in FIG. 2 as “a′\x1e\x80\x0eZ\x8c7\xc0C\r/%″xec\x94\x81!\x1d\xae(\x8c\x)e5\xfc\x8e\xaaJ\xbdFi- F\xe3′.” Then, for the second instance, the prior art encryption would replace the word “James Johnson” with, for example, a key such as “v′\asve74\sh9065\x8e4\49v1a\b91$nf5\x93\m7d1adde\xv4′.” The second key, as generated by the prior art encryption, for the same word “James Johnson” is different from the first key. This practice continues for all instances of the same word so that each key is different from all other keys. However, such a practice as performed via prior art encryption fails to maintain referential integrity. Thus, the information encrypted via prior art encryption is difficult for LLM 16 to use because LLM 16 cannot determine that any words that are replaced by keys (e.g., words that are encrypted) are the same and/or different from other encrypted words and cannot draw consistent and accurate conclusions from the encrypted information.

Replacement module 36 having referential integrity 38 can include and/or work in conjunction with any models, systems, software, etc., such as a machine learning model and/or a generative artificial intelligence model, that is able to replace words to be encrypted with corresponding keys. Furthermore, replacement module 36 can be configured to generate and/or add information to word-key pair database 40. For example, replacement module 36 can be configured to record, in word-key pair database 40, the number of times a particular key is used to replace a particular word, the placement of the words/keys within encrypted information and/or the encrypted prompt, and/or any other information. Replacement module 36 can be configured to manually replace the words to be encrypted with the corresponding keys and/or add information to word-key pair database 40 as performed by and/or initiated by a user/operator. Additionally and/or alternatively, replacement module 36 can be configured to automatically replace the words to be encrypted with the corresponding keys in response to, for example, the completion of the generation of keys for words to be encrypted (e.g., by key generation module 32) and/or the reception of/access to word-key pair database 40 by replacement module 36 such that replacement module 36 has the requisite information (words to be encrypted and the corresponding keys) to perform the particular tasks (replacing words with keys). The automatic replacement of words with keys can be, for example, in response to any other triggering events/instructions. Replacement module 36 can be, for example, in communication with storage media 22 to access and/or receive information, such as word-key pair database 40, to determine which words are to be encrypted and identify the keys that correspond to those words so as to be able to replace those words with the corresponding keys.

As described above, “\word-key pair database 40 can be any physical and/or digital component capable of storing electronic information in an organized manner that enables later retrieval of the electronic information. For example, word-key pair database 40 can be a spreadsheet and/or database that is known to one of skill in the industry and is acceptable by programs, systems, etc. for use by, for example, any of the components of system 10 (e.g., identification module 30, key generation module 32, and/or replacement module 36). While shown as being stored/saved in storage media 22, word-key pair database 40 can be stored/saved at any location that allows for system 10 to receive and/or access the information within word-key pair database 40, such as in the cloud and/or at a location distant from system 10. In one example, word-key pair database 40 can have multiple rows and/or columns that detail the words to be encrypted as well as the keys corresponding to those words to be encrypted for any unencrypted information and/or unencrypted prompts. As described above, word-key pair database 40 can include other information, such as the number and/or location of the words to be encrypted that are replaced by the corresponding keys. System 10 and/or the processes described herein can include and/or use one or multiple word-key pair databases 40. For example, a new word-key pair database 40 can be generated/formulated in response to new/different unencrypted information and/or unencrypted prompts being provided to system 10 for encryption. Additionally and/or alternatively, one word-key pair database 40 can be used for the entirety of a session of communication with and/or analysis by LLM 16. After the session has been completed, the word-key pair database 40 can be deleted and/or otherwise replaced with new words to be encrypted and/or new corresponding keys from different unencrypted information/prompts. Moreover, one word-key pair database 40 can be used for multiple sessions with LLM 16 such that the same keys are used for the same words whether the unencrypted information/prompts are different or not as compared to the previous unencrypted information/prompts. In another example, word-key pair database 40 is periodically deleted/discarded and the words to be encrypted as well as the corresponding keys are reidentified, generated, and/or replaced. The generation/formulation, use, and/or deletion/discarding of word-key pair database 40 can be performed by any components of system 10 and/or can follow any processes.

Replacement module 36 can also be configured to replace the keys in any encrypted information, such as the encrypted output (and/or the encrypted query as discussed with regards to system 110), with the corresponding words to form unencrypted outputs/queries having the original words (e.g., the outputs/queries are “unencrypted” by replacement module 36). Replacement module 36 can perform the replacement of keys with the corresponding words This can be performed manually by a user/operator as described above and/or automatically in response to, for example, the access to and/or reception of, by replacement module 36, the encrypted outputs/queries and/or in response to any other triggering events/instructions.

System 10 can include and/or work in conjunction with prompt module 14 and/or LLM 16. Prompt module 14 and/or LLM 16 can include and/or function in conjunction with any of the other components of system 10 (such as processor 20, storage media 22, and/or user interface 24). Prompt module 14 and/or LLM 16 can work together to determine one and/or multiple encrypted outputs based upon the encrypted information and/or unencrypted/encrypted prompt(s). Additionally and/or alternatively, prompt module 14 and/or LLM 16 can determine/generate other information. System 10 can receive information from and/or provide information to prompt module 14 and/or LLM 16. While shown in FIG. 1 as being separate and distinct from system 10, prompt module 14 and/or LLM 16 can be within system 10 (e.g., components of system 10). For example, network analysis system 110 as shown in FIG. 3 has a prompt module included therein as described below. In such a configuration, prompt module 14 can be distinct from encryption system 10 and instead can be a component of network analysis system 110.

Prompt module 14 can be configured to prompt/request LLM 16 to perform various specified tasks to determine/generate at least one encrypted output, and/or prompt module 14 can be configured to prompt/request LLM 16 to perform other tasks and/or generate other outputs not expressly disclosed herein. Prompt module 14 can be configured to provide and/or otherwise allow access to other information useful and/or necessary for LLM 16 to perform the prompted tasks and/or instructions. Additionally and/or alternatively, prompt module 14 can provide unencrypted prompt(s) to encryption system 10 for encryption before encrypted prompt(s) are provided to LLM 16. In another configuration, prompt module 14 can provide unencrypted prompt(s) directly to LLM 16 if the information in unencrypted prompt(s) is not to be encrypted and/or if a user/operator does not desire to encrypt the unencrypted prompt(s) generated by prompt module 14 and/or provided to LLM 16. In a third configuration, encrypted information can be provided to prompt module 14 and prompt module 14 can generate encrypted prompt(s) dependent upon that encrypted information. Then, the encrypted prompt(s) can be provided to LLM 16 directly and/or through encryption system 10 and then from encryption system 10 to LLM 16. The prompt(s) as generated, assembled, and/or otherwise used by prompt module 14 can include any information, such as example descriptions that provide guidance as to content, layout, etc. of the encrypted output(s). The prompt to LLM 16 as generated, assembled, etc. by prompt module 14 can include other information, request LLM 16 to perform other determinations, and/or request LLM 16 to make those determinations in a variety of different ways/processes. The request to LLM 16 by prompt module 14 can be a simple request/prompt that can include only one question/query/inquiry or can be a complex/compound request/prompt that can include/request a series of separate steps/tasks performed sequentially, concurrently, and/or in another fashion to return desired results. Prompt module 14 can be configured to generate and/or include any information, requests, etc. in the one and/or multiple prompts to LLM 16. In one example, each prompt to LLM 16 is newly generated by prompt module 14 while in another example, a portion and/or all of a prior prompt is reused to generate a subsequent prompt to LLM 16.

Prompt module 14 can be configured to generate, assemble, etc. one and/or multiple prompts for LLM 16 manually as initiated and/or generated by a user, and/or prompt module 14 can be configured to automatically generate/assemble one or multiple prompts for LLM 16 in response to, for example, the reception of and/or access to unencrypted and/or encrypted information. Additionally and/or alternatively, prompt module 14 can be configured to automatically generate prompt(s) in response to any other triggering events/instructions. The generation of one or multiple prompts 14 can be periodic and/or continuous as initiated by, for example, the reception/access to new and/or modified unencrypted and/or encrypted information. The prompts as generated by prompt module 14 can be saved at any location (e.g., storage media 22) and/or immediately and/or quickly provided/sent to LLM 16 for execution by LLM 16.

System 10 can include and/or work in conjunction with, receive information from, and/or provide information to one or multiple LLMs 16. In one configuration, LLM 16 is a separate and distinct component/system from system 10, and LLM 16 accesses and/or otherwise receives encrypted information/prompts (and/or other information, databases, graphs, etc.) from system 10 and/or prompt module 14 via, for example, the internet. In another configuration, LLM 16 can be within (e.g., a component of) and/or work in conjunction with system 10.

LLM 16 and similar models are increasingly common deep learning algorithms that can recognize, summarize, describe, translate, predict, and/or generate content using large datasets, which can include information available and/or accessed on the internet. LLM 16 can be used to process simple or complex requests which, for example, demand retrieval of data from multiple or specialized sources, assemble outputs (e.g., natural language, computer code, lists, graphs, and/or databases) from the retrieved data based on identified criteria, and/or further process those outputs (e.g., transmission or archival to specified categories or locations and/or recipients). LLM 16 can include a generalized LLM, specialized LLM, and/or other models. LLM 16 can be one or multiple models and/or other systems known to one of skill in the industry for retrieving, organizing, summarizing, manipulating, and/or performing other functions with regards to information in response to one or multiple requests from, for example, prompt module 14 and/or system 10. LLM 16 can be configured to communicate with (e.g., provide information to and receive information from) prompt module 14 and/or any of the components of system 10 and/or other components/systems. Because LLM 16 may be accessible via the internet and/or may use the internet to determine/generate outputs, it may be advantageous to encrypt, via encryption system 10, any/all information provided to LLM 16. Also, because LLM 16 can accept natural language as an input and/or provide outputs in natural language, it may be advantageous for the encrypted information provided to LLM 16 to both preserve the format of the encrypted words as well as maintain referential integrity of the encrypted words.

In response to one or multiple unencrypted and/or encrypted prompts from prompt module 14 (and/or the reception of and/or access to unencrypted and/or encrypted information), LLM 16 can be configured to determine/generate at least one encrypted output. The encrypted output can be, for example, any conclusion regarding information source 12 (such as digital network 12A and/or graph database 12B representative of the digital network 12A). The encrypted output can be, for example, 1) an explanation as to why device(s) of the digital network failed to connect as requested in an unencrypted/encrypted prompt; 2) the digital network response(s) to outage(s) as requested in an unencrypted/encrypted prompt; 3) a formulation of databases and/or graphs that reflect the configuration of at least a portion of the digital network; 4) a query, such as a Cypher query, that is used by graph database management system 18A to retrieve, evaluate, analyze, etc. information in graph database 12B and/or provide a conclusion as requested in the query; and/or 5) other outputs not expressly disclosed herein.

The encrypted output as determined/generated by LLM 16 in response to unencrypted/encrypted prompt and/or the encrypted information is referred to herein as an “encrypted” output (as opposed to an “unencrypted” output) because the encrypted output is determined by LLM 16 based at least partially upon encrypted information and/or an encrypted prompt. If the output is based upon unencrypted information and an unencrypted prompt (so thus does not contain any keys), the output would be referred to as an “unencrypted” output. Once encryptions system 10 unencrypts the encrypted output as detailed below, the output then becomes an “unencrypted” output because the output no longer contains any encryption (i.e., it no longer contains any keys in place of any previously encrypted words).

After determining/generating the encrypted output, system 10 can receive (e.g., from LLM 16), access, and/or otherwise use the encrypted output to convert the encrypted output to an unencrypted output. System 10, and for example replacement module 36, can be configured to replace all keys in the encrypted output with the corresponding words. Word-key pair database 40 can be used by replacement module 36 to determine the keys that need to be replaced and the corresponding words that those respective keys should be replaced with. Replacement module 36 can replace all instances of each key with the corresponding word to create/generate the unencrypted output. For example, the device “Park Place 4^{th} Floor Router” (as shown in FIG. 2) in the unencrypted information can be encrypted by system 10 such that every instance of the device name as it appears in the unencrypted information is replaced with the key “Adams Device” to form the encrypted information. The encrypted information (having “Adams Device”) can be provided to LLM 16 along with an unencrypted and/or encrypted prompt. The example prompt can request that LLM 16 explain why the Adams Device failed to connect to other devices in the digital network. LLM 16 can determine/generate an encrypted output that satisfies the prompt. The encrypted output can include the key (e.g., term/device name) “Adams Device.” Then, system 10 replaces the key “Adams Device” in the encrypted output with the actual device name (e.g., the word corresponding to the key), which is “Park Place 4^{th} Floor Router,” to create/generate the unencrypted output. Thus, the unencrypted information is reflected in the unencrypted output without providing unencrypted information to LLM 16.

The unencrypted output can be saved at any location (e.g., storage media 22) and/or immediately and/or quickly provided, allow access to, and/or otherwise used by end user/system 18 for review, evaluation, modification, and/or further analysis. In one example, end user/system 18 can be graph database management system 18A, which uses the unencrypted output (e.g., a query) with graph database 12B to determine further conclusions regarding, for example, digital network 12A. In another example, end user/system 18 is users 18B that reviews, organizes, summarizes, modifies, and/or performs other functions to unencrypted output. In example process 200 described below, the unencrypted output is a query that is provided to a graph database management system 18A to generate/determine a query response (which can be an answer to the query) based upon and/or using information within graph database 18A. End user/system 18 can be a component within encryption system 10 and/or a separate and distinct system from encryption system 10.

As described above, encryption system 10 ensures that the encrypted information and/or encryption prompts provided to LLM 16 preserve the format of the word that is being encrypted (e.g., the word to be encrypted that is replaced by a corresponding key) as well as maintains referential integrity such that the same word to be encrypted is replaced by the same corresponding key. Thus, the encrypted information and/or encrypted prompts provided to LLM 16 are consistent in format and context to allow LLM 16 to make inferences based upon the format and context of the encrypted information and/or prompts to determine/generate consistent and accurate encrypted output(s). Encryption system 10 allows for the user/operator to maintain control and/or possession of the sensitive information while still being able to use LLM 16 to determine outputs. In other words, the operator/user does not need to provide the sensitive information to LLM 16 and can instead use encryption system 10 to replace sensitive information with randomly generated keys (e.g., encryption) that preserve the format of the sensitive information as well as maintain referential integrity. System 10 can include other capabilities, configurations, functionalities, and advantages than those detailed above. As shown and described with regards to FIG. 3 below, network analysis system 110 is another example system that allows a user/operator to maintain control and/or possession of most or all of the information while also being able to use LLM 116.

FIG. 3 is a block schematic diagram of example network analysis system 110 (hereinafter also referred to just as “system 110”) functioning in conjunction with and/or including LLM 116. System 110 is configured to analyze a digital network via LLM 116 without providing a large amount of information regarding the digital network to LLM 116. System 110 allows for LLM 116 to generate/determine a query that is then used by graph database management system 126 with graph database 112B (that include network information 112C) to generate/determine a query response that is associated with the digital network represented by graph database 112B. The query response (and/or information dependent upon the query response) can then be provided back to LLM 116 for LLM 116 to generate/determine a natural language output from the query response, which allows a user/operator to more easily understand the query response based upon graph database 112B and regarding the digital network. Thus, graph database 112B, along with network information 112C, remains under the control/possession of system 110 (e.g., the user/operator of system 110) and does not need to be provided to LLM 116 while still allowing for the determination of a natural language output dependent upon the digital network (represented by graph database 112B). Such capabilities may be advantageous when graph database 112B (and/or other information) is sensitive and/or protected.

Network analysis system 110 can be in communication with, use, and/or include any system, component, etc. to receive, access, and/or otherwise use desired output 150. Desired output 150 can, for example, be and/or include an explanation as to why device(s) failed to connect 152A, the network response to outage(s) 152B, and/or a device connectivity analysis 152C. Further, system 110 can be in communication with, use, and/or include LLM 116 and/or end user/system 118. Network analysis system 110 can include, among other components not expressly disclosed herein, processor 120, storage media 122, user interface 124, graph database management system 126 (which in turn can include and/or use graph database 112B having network information 112C), and/or prompt module 114. In another configuration/example, desired output 150 is selected/generated using user interface 124 and thus is within system 110. In a third configuration/example, prompt module 114 is a separate and distinct component from system 110 and is in communication with system 110 and/or LLM 116. In a fourth configuration/example, one or both of LLM 116 and/or end user/system 118 are components/systems within and/or otherwise associated with system 110. Any of the systems/components shown in FIG. 3 can communicate via the internet and/or other communication methods, such as wired and/or wireless communication.

Network analysis system 110 can, in another configuration, include one, multiple, and/or all components and/or capabilities of encryption system 10. In this configuration of a combined network analysis system 110 and encryption system 10 (and/or a configuration in which systems 10 and 110 function together), any information, prompts, queries responses, etc. that are sent out from network analysis system 110 are first encrypted by encryption system 10. Thus, before the information and query prompts are provided to LLM 116, encryption system 10 encrypts them. Then, encryption system 10 unencrypts the queries for use by graph database management system 126. After that, before the query responses and output prompts are provided to LLM 116 by network analysis system 110, encryption system 10 encrypts them. LLM 116 can then generate encrypted natural language outputs (they are encrypted because they are based upon the encrypted query responses and encrypted output prompts). Finally, encryption system 10 can unencrypt the natural language outputs and, for example, provide the unencrypted natural language outputs to end user/system 118. The process that combines the capabilities of both encryption system 10 and network analysis system 110 is described as example process 200 below with regards to FIG. 4.

FIG. 3 focuses on hardware components of network analysis system 110, and is provided as an illustrative example of a general hardware system for performing the capabilities discussed herein. The components presented in FIG. 3, particularly including graph database management system 126 and/or prompt module 114 (and associated components) can be omitted or replaced with analogous hardware and/or software in different architectures without departing from the scope and spirit of the present disclosure.

Network analysis system 110 can access, receive, and/or otherwise use desired output 150 to determine, guide, and/or decide on actions/instructions to arrive at a natural language output that satisfies the inquires and/or needs set out in desired output 150. Desired output 150 can be determined/selected using any systems, components, user interfaces, etc., such as user interface 124 of system 110. In the example shown in FIG. 3 and described herein, desired output 150 is directed to determining an output regarding a digital network that, for example, is represented at least partially by the information contained within graph database 112B (e.g., at least partially by network information 112C). For example, desired output 150 can be and/or include an explanation as to why device(s) failed to connect 152A on the digital network, the digital network's response to outage(s) 152B, and/or a device connectivity analysis 152C of a device on the digital network. Desired output 150 can be any explanation, investigation, evaluation, conclusion, etc. that is desired by a user/operator regarding the digital network and/or any other information. Additionally, desired output 150 can be dependent upon the digital network and/or graph database 112B. In one example, desired output 150 is generated anew by the user/operator via user interface 124. In another example, desired output 150 is selected from a list of potential outputs that can be determined by system 110 (along with LLM 116) via user interface 124. In a third example, desired output 150 is determined manually and/or automatically based upon an error and/or another event that is occurring on the actual digital network represented by graph database 112B. For example, a device named “Main Loft Modem” on the actual digital network fails to connect to a device named “Guest Room 156 Media Center.” Desired output 150 can be an explanation as to why the Main Loft Modem has failed to connect to the Guest Room 156 Media Center. Desired output 150 can be determined/selected at any location and/or use any systems, components, etc., as long as desired output 150 is communicated to and/or in communication with network analysis system 110.

Network analysis system 110 (and/or the components of system 110) can include one or multiple computer/data processors 120 (also referred to herein as “processors 120”). Processor 120 can be similar to processor 20 of system 10 in configuration, capability, and/or functionality. Refer to the discussion with regards to processor 20 of system 10 above for additional details. Additionally, processor 120 can perform other computing processes described herein with regards to system 110, such as the functions performed by any of the components of system 110 and/or any other systems/components shown in FIG. 3. Moreover, in one configuration, processor 20 and processor 120 can be the same component used by and/or associated with both system 10 and system 110.

Network analysis system 110 (and/or the components of system 110) can include storage media 122 (also referred to herein as “storage media 112”). Storage media 122 can be similar to storage media 22 of system 10 in configuration, capability, and/or functionality. Refer to the discussion with regards to storage media 22 of system 10 above for additional details. Additionally, storage media 122 can be configured to store any information/instructions associated with system 110, such as graph database 112B, network information 112C, desired output 150, the query prompts (as determined by prompt module 114) and associated information, the query (as generated/determined by LLM 116), the query response (as determined by graph database management system 126) and associated output prompt (as determined by prompt module 114), the natural language output (as generated/determined by LLM 116), and/or any other information regarding any of the components of system 110 and/or any other systems/components shown in FIG. 3.

Network analysis system 110 (and/or the components of system 110 and/or other components/systems shown in FIG. 3) can include user interface 124, which can be similar to user interface 24 of system 10 in configuration, capability, and/or functionality. Refer to the discussion with regards to user interface 24 of system 10 above for additional details. Additionally, user interface 124 can be used to determine/select desired output 150, and user interface 124 can be used to view and/or alter any information regarding system 110, including desired output 150, graph database 112B, network information 112C, the query prompts (as determined by prompt module 114) and associated information, the query (as generated/determined by LLM 116), the query response (as determined by graph database management system 126) and associated output prompt (as determined by prompt module 114), the natural language output (as generated/determined by LLM 116), and/or any other information.

System 110 can include and/or work in conjunction with graph database management system 126. Graph database management system 126 can include and/or function in conjunction with any of the other components of system 110 (such as processor 120, storage media 122, and/or user interface 124). Graph database management system 126 can access, receive, and/or otherwise use a query as generated/determined by LLM 116. Graph database management system 126 is configured to perform the query on graph database 112B to generate the requested results (e.g., a query response) as requested in the query. In one example, graph database management system 126 is Neo4j and the query is a Cypher query. Thus, graph database management system 126 can perform the Cypher query on graph database 112B to determine/generate an answer/satisfy the request set out in the Cypher query. Graph database 112B can be in a usual format for a graph database that is known to one of skill in the industry and is acceptable by programs, systems, etc. familiar with accepting/accessing information in a graph database, such as graph database management system 126. Further, graph database management system 126 can also be a system that is known to one of skill in the industry for accepting and/or using a query to determine/generate information, answers, results, etc. in response to the query (e.g., a query response). The information, answers, results, etc. as determined/generated by graph database management system 126 in response to the query is referred to herein as a “query response” and can include network information 112C as set out in graph database 112B. Graph database management system 126 can be in communication with LLM 116 to access, receive, and/or otherwise use the query as generated/determined by LLM 116 and/or to allow for LLM 116 to access, receive, and/or otherwise use the query response as generated/determined by graph database management system 126. Graph database management system 126 can have electronic storage capabilities to store graph database 112B, and/or graph database management system 126 can be in communication with storage media 122 such that graph database 112B and/or the query are stored therein and accessed, received, and/or otherwise used by graph database 126. Graph database management system 126 can be configured to manually generate/determine the query responses as performed by and/or initiated by a user/operator, and/or graph database management system 126 can be configured to automatically generate/determine the query responses in response to, for example, the reception of the queries from LLM 116 and/or in response to any other triggering events/instructions.

System 10 include and/or work in conjunction with prompt module 114 and/or LLM 116. Prompt module 114 and/or LLM 116 can be similar to prompt module 14 and/or LLM 16 of system 10, respectively, in configuration, capability, and/or functionality. Refer to the discussion with regards to prompt module 14 and/or LLM 16 of system 10 above for additional details. Prompt module 114 and/or LLM 116 can include and/or function in conjunction with any of the other components of system 110 (such as processor 120, storage media 122, and/or user interface 124). Prompt module 114 and/or LLM 116 can work together to determine the natural language output that satisfies the request/goal set out in desired output 150 without LLM 116 having access and/or otherwise being provided graph database 112B and/or an excessive amount of information regarding the digital network. Additionally and/or alternatively, prompt module 114 and/or LLM 116 can determine/generate other information, and system 110 can receive information from and/or provide information to prompt module 114 and/or LLM 116. While shown in FIG. 3 as being within system 110 (e.g., a component of system 110), prompt module 114 can be separate and distinct from system 110. Moreover, while shown in FIG. 3 as being separate and distinct from system 110, LLM 116 can be included within system 110. However, the general configuration of a large language model is that it is separate and distinct from other systems and communicates with those systems via the internet.

Prompt module 114 can be configured to determine and/or generate one or multiple prompts/requests to LLM 116 to perform various specified tasks to, for example, determine/generate queries and/or natural language outputs (depending on the specific prompt). Prompt module 114 can access, receive, and/or otherwise use desired outputs 150, network information 112C from graph database 112B, the query responses, and/or other information to generate/determine query prompts and/or output prompts.

In one example, prompt module 114 uses desired output 150 and/or network information 112C from, associated with, and/or based upon graph database 112B to generate a query prompt to LLM 116. The query prompt can be, for example, a request to LLM 116 to generate/determine a query that, when used by graph database management system 126, generates a query response satisfying desired output 150. For example, the query prompt can request LLM 116 to generate a Cypher query for use by graph database management system 126, which is Neo4j. Prompt module 114 can then use the query response and/or network information 112C from, associated with, and/or based upon graph database 112B to generate an output prompt to LLM 116. The output prompt can be, for example, a request to LLM 116 to generate/determine a natural language output based upon the query response, with the natural language output being more easily understood than the query response, which may be in a format that is not as easily discernable by end user/system 118. Thus, prompt module 114 can be in communication with any of the systems/components shown in FIG. 3, including desired output 150 and/or LLM 116.

The prompt(s) as generated, assembled, and/or otherwise used by prompt module 114 can include any information, such as example descriptions that provide guidance as to content, layout, etc. of the queries, natural language outputs, etc. The prompts to LLM 116 as generated, assembled, etc. by prompt module 114 can include other information, request LLM 116 to perform other determinations, and/or request LLM 116 to make those determinations in a variety of different ways/processes. The prompts to LLM 116 by prompt module 114 can be simple requests/prompts that can include only one question/query/inquiry or can be complex/compound requests/prompts that can include/request a series of separate steps/tasks performed sequentially, concurrently, and/or in another fashion to return desired results. Prompt module 114 can be configured to generate and/or include any information, requests, etc. in the one and/or multiple prompts to LLM 116. In one example, each prompt to LLM 116 is newly generated by prompt module 114 while in another example, a portion and/or all of a prior prompt is reused to generate a subsequent prompt to LLM 116.

Prompt module 114 can be configured to generate, assemble, etc. one and/or multiple query prompts and/or output prompts for LLM 116 manually as initiated and/or generated by a user, and/or prompt module 114 can be configured to automatically generate/assemble one or multiple query prompts and/or output prompts for LLM 161 in response to, for example, the reception of and/or access to desired output 150 and/or query response, respectively. Additionally and/or alternatively, prompt module 114 can be configured to automatically generate prompt(s) in response to any other triggering events/instructions. The generation of prompts can be periodic and/or continuous as initiated by, for example, the reception/access to new and/or modified desired outputs 150, graph database 112B, network information 112C, and/or query responses. The prompts as generated by prompt module 114 can be saved at any location (e.g., storage media 122) and/or immediately and/or quickly provided/sent to LLM 116 for execution by LLM 116.

In response to one or multiple query prompts from prompt module 114 (and/or the reception of and/or access to any associated information, such as desired output 150 and/or network information 112C), LLM 116 can be configured to determine one or multiple queries. Each query can be, for example, instructions/requests understood by graph database management system 126 that, when performed on graph database 112B, return a query response that satisfies desired output 150. The queries as determined by LLM 116 can be in any format, configuration, etc. so as to be useful to graph database management system 126. After determining each query, LLM 116 can be configured to provide and/or allow access to the query by system 110 (e.g., by graph database management system 126).

Further, in response to one or multiple output prompts from prompt module 114 (and/or the reception of and/or access to any associated information, such as network information 112C), LLM 116 can be configured to determine one or multiple natural language outputs. Each natural language output can be based upon the query response and/or other information and can put the query response in more easily understandable syntax, format, context, etc. than the query response, which may be in a format that is not as easily discernable by end user/system 118. After determining each natural language output, LLM 116 can be configured to provide and/or allow access to the natural language output by, for example, end user/system 118 and/or by any other locations/components, such as system 110 (e.g., for viewability and/or alteration via user interface 124).

Network analysis system 110 allows for the determination/generation of a natural language output by LLM 116 based upon and/or associated with a digital network, which is at least partially represented by graph database 112B, without the need for system 110 to provide a portion or all of graph database 112B to LLM 116. Thus, system 110 allows for the user/operator to maintain control/possession of most or all information associated with the digital network, which may be sensitive, instead of being required to send the information to LLM 116 via the internet and/or other communications. Such capabilities (i.e., maintaining control/possession of digital network information) are advantageous in a landscape in which data breaches and/or the interception of information transmitted via the internet is common. Furthermore, graph database 112B can contain information regarding thousands of devices on the digital network, so the electronic size of graph database 112B may be extremely large. During such a situation, the transmission of such a large file (i.e., the graph database 112B) from system 110 to LLM 116 may take an extended period of time and thus slow the process of determining/generating the natural language output that satisfies/achieves the goal set out in desired output 150. System 110 can include other capabilities, configurations, functionalities, and advantages than those detailed herein. A process that includes both the capabilities and/or advantages of system 10 as described with regards to FIG. 1 and system 110 as described with regards to FIG. 3 is described below with reference to FIG. 4.

FIG. 4 is a method flow chart describing example process 200 for encrypting information for use with a large language model to analyze a digital network via a representative graph database, among other elements and/or steps as described below. While process 200 is described herein as being used with regards to encryption system 10 and/or network analysis system 110, process 200 can be performed by any system(s) having any components, capabilities, configurations, and/or functionalities suitable for performing process 200. Additionally, process 200 can include other steps not expressly disclosed herein and/or can include performing the disclosed steps in any order and/or multiple times as is desired and/or necessary to generate/determine one or multiple prompts, outputs etc., whether encrypted and/or unencrypted. Moreover, not all steps of process 200 must be performed, and process 200 can be performed partially and/or entirely in a digital environment by and/or within the systems/components set out in this disclosure, such as encryption system 10, network analysis system 110, and/or other systems/components.

Process 200 can include step 202, which is to formulate, select, and/or collect a desired output and/or unencrypted information. This information can be desired output 150 and/or any information, including unencrypted information from information source 12, that can depend upon and/or include information from digital network 12A and/or graph database 12B. As described above, the information formulated, selected, and/or collected in step 202 can be formulated/collected by a user/operator, can be selected from a list/menu of preformulated desired outputs/information, and/or can be automatically formulated/collected in response to instructions (e.g., a triggering event), such as the generation of graph database 12B to represent digital network 12A. The information in step 202 can be any information from which an output is to be determined.

Process 200 can include step 204, which is to access, receive, and/or otherwise use the desired output and/or unencrypted information. After the desired output and/or unencrypted information is formulated, selected, and/or otherwise collected in step 202, that information is allowed to be accessed, provided to, and/or otherwise used by, for example, encryption and/or network analysis system 10/110. Desired output 150 and/or the unencrypted information can be formulated and/or selected using, for example, any of the components of system 10/110 (e.g., user interface 24/124) and/or can be stored within storage media 22/122 for access by any components of system 10/110.

Process 200 can include steps 206-212 for encrypting information (desired output 150, prompts, etc.) to be used by and/or provided to the LLM. If encryption is not described, these steps (as well as other steps associated with encryption of information) do not need to be performed during process 200.

Process 200 can include step 206, which is to identify words in the desired output and/or unencrypted information (that is to at least partially be provided to the LLM) that is to be encrypted. Step 206 can be performed by, for example, identification module 30 as detailed with regards to encryption system 10. Additionally and/or alternatively, step 206 can be performed by any components of systems 10/110 and/or any systems capable of determining sensitive, proprietary, and/or protected information. For example, step 206 can be performed by name recognition artificial intelligence software that is able to identify the words/information to be encrypted. Step 206 can also include generating and/or adding words/information to word-key pair database 40, such as generating a word side/column and adding words to be encrypted to the word side/column in word-key pair database 40. In another example, the word-key pair database 40 is already in existence (e.g., has previously been generated) and step 206 includes adding to and/or otherwise substituting words in word-key pair database 40. Step 206 can be performed manually such that words to be encrypted are manually identified/determined by a user/operator. Moreover, step 206 can be performed automatically such that words to be encrypted are identified/generated in response to, for example, the reception of desired output 150, unencrypted information, unencrypted prompts, and/or any other triggering events/instructions. Example types of “words” to be encrypted are detailed above with regards to the description of identification module 30 in encryption system 10.

Process 200 can include step 208, which is to generate keys corresponding to words to be encrypted. Step 208 can be performed by, for example, key generation module 32 having format preservation 34 as detailed with regards to encryption system 10. Additionally and/or alternatively, step 208 can be performed by any components of systems 10/110 and/or any systems capable of generating keys corresponding to words to be encrypted. Step 208 includes generating keys that have a similar format to the corresponding words to be encrypted as described with regards to key generation module 32. The specific keys generated in step 208 can be random (while preserving the format of the corresponding word) or can be dependent upon the previous generation of keys, such as dependent upon keys in word-key pair database 40 that have previously been generated. Step 208 can include evaluating a format of the specific word and generate a key that has a similar format to that corresponding word to be encrypted. For example, process 208 can determine that the word to be encrypted is an individual name and generate a key that is the same format as a name. In the example shown in FIG. 2, the actual/unencrypted individual name is “James Johnson,” and step 208 includes determining that “James Johnson” is an individual name that is to be encrypted and generates a key that is “Dakota Rainbow,” which is an individual name having the same format as “James Johnson.” Step 208 can perform this evaluation for any word to be encrypted and generate a key preserving the format for any of the words to be encrypted. Step 208 can be performed manually to generate keys corresponding to the words to be encrypted as performed by and/or initiated by a user/operator. Additionally and/or alternatively, step 208 can be performed automatically in response to, for example, the reception of word(s) to be encrypted and/or the addition of word(s) to be encrypted to word-key pair database 40. The automatic evaluation and/or generation of keys can be in response to, for example, any other triggering events/instructions. Step 208 can include saving the keys in word-key pair database 40 and/or in storage media 22 and/or 122.

Process 200 can include step 210, which is to replace words to be encrypted with the corresponding keys to form encrypted information, encrypted prompts, and/or any other encryption of information that is to be provided or otherwise used by the LLM. Step 210 can be performed by, for example, replacement module 36 having referential integrity 38 as detailed with regards to encryption system 10. Additionally and/or alternatively, step 210 can be performed by any components of systems 10/110 and/or any systems capable of replacing words to be encrypted with the corresponding keys to create/generate encrypted information (e.g., encrypted desired outputs 150, encrypted prompts, and/or any other encrypted information that is to be provided and/or used by the LLM). Step 210 can be performed multiple times for all words to be encrypted and the corresponding keys in each document, prompt, desired output 150, etc. For example, if an unencrypted prompt includes thirty-eight words to be encrypted (as identified in step 206), step 210 can be performed thirty-eight times to replace all words to be encrypted with all corresponding keys. Step 210 also includes replacing the same word to be encrypted with the same corresponding key for each instance that the word appears in the encrypted information/document. For example, each time the word/individual name “James Johnson” appears in the unencrypted prompt, the key “Dakota Rainbow” is used to replace “James Johnson” so that referential integrity is maintained (e.g., when referencing “Dakota Rainbow” in any prompts, outputs by the LLM, etc., referential integrity allows for it to be known that every instance/reference to “Dakota Rainbow” actually is a reference to “James Johnson”). Step 210 can be referred to as the collective replacement of any words to be encrypted for each unencrypted document that is desired to be encrypted, so step 210 can be performed multiple times for multiple documents/information/prompts. Step 210 can include accessing and/or otherwise using word-key pair database 40 such that step 210 is performed using/referring to word-key pair database 40 to replace one, multiple, or all words that appear in word-key pair database 40 with the corresponding key that is associated with the word(s) in word-key pair database 40. Step 210 can be performed manually to replace words to be encrypted with the corresponding keys as performed by and/or initiated by a user/operator. Additionally and/or alternatively, step 210 can be performed automatically in response to, for example, the completion of the generation of keys (e.g., the completion of step 208) and/or the reception of word-key pair database 40 that has keys corresponding to all words to be encrypted. The automatic replacement of words with keys can be in response to, for example, any other triggering events/instructions. Step 210 can include saving the encrypted information, prompts, desired outputs 150, etc. in, for example, storage media 22/122 and/or at any other location.

Process 200 can include step 212, which is to save the words to be encrypted and the corresponding keys in word-key pair database 40. Step 212 can be performed at any time before, during, and/or after steps 206, 208, and/or 210 as is desired and/or necessary to encrypt the designated unencrypted information, prompts, and/or desired outputs 150. Step 212 can also include generating and/or creating the word-key pair database 40. Step 212 can be performed once and/or multiple times as is necessary to record the words to be encrypted and associate the corresponding keys with those words. Word-key pair database 40 is described above with regards to encryption system 10. Step 212 can be performed manually and/or initiated manually by a user/operator, and/or step 212 can be performed automatically in response to, for example, the identification of words to be encrypted, the generation of keys corresponding to those words, and/or the replacement of those words with the corresponding keys. Moreover, the automatic performance of step 212 can be performed in response to any other triggering events/instructions. Step 212 can include saving word-key pair database 40 to any location, including in storage media 22 and/or 122.

Step 214 of process 200 can include generating one or multiple query prompts. Step 214 can be performed by, for example, prompt module 14 and/or 114 as detailed with regards to the systems/modules associated with encryption system 10 and network analysis system 110, respectively. Additionally and/or alternatively, step 214 can be performed by any components of system 10/110 and/or any systems capable of generating/determining prompts (e.g., query prompts and/or outputs prompts). The query prompt, as generated in step 214, can be, for example, a request to the LLM to generate/determine a query that, when used by a graph database management system (such as system 126 shown and described with regards to network analysis system 110), generates a query response that satisfies the desired output and/or any other request for information regarding the digital network represented by the graph database. In one example, the query prompt as generated in step 214 requests that the LLM generate a Cypher query, and the query prompt can include an example Cypher query that is provided to the LLM for guidance. In a later step, the Cypher query is then provided to a graph database management system such as a Neo4j system.

Moreover, step 214 (generating one or multiple query prompts) can be performed before, during, and/or after any of the encryption steps (steps 206-212) so that the query prompts are also encrypted before being provided to, accessed by, and/or otherwise used by the LLM. Step 214 can be performed manually to generate the query prompts as performed by and/or initiated by a user/operator, or step 214 can be automatically performed in response, to for example, the reception, generation, selection, etc. of desired output 150, encrypted information, and/or any other triggering events/instructions. Step 214 can include saving the query prompts in storage media 22 and/or 122 and/or compiling the query prompt(s) with associated encrypted information (and/or other information, such as example descriptions that provide guidance as to content, layout, etc. of the queries) that is necessary for the LLM to determine a corresponding query in response to the query prompt.

Next, process 200 includes step 216, which is to provide the encrypted information and/or query prompt to the LLM. Step 216 can be performed by, for example, prompt modules 14 and/or 114, systems 10 and/or 110 generally, and/or via any wired and/or wireless communication. In one example, prompt modules 14/114 and/or systems 10/110 are in communication with the LLM, such as LLMs 16 and/or 116, via the internet. As described above, the encrypted information provided to the LLM along with the query prompt is any information that is necessary for the LLM to determine a corresponding query as requested/instructed by the query prompt. The encrypted information can include, for example, desired outputs 150, network information 112C, and/or any information regarding the digital network and/or the graph database (such as graph database 112B) representative of the digital network. Furthermore, the encrypted information can include any query examples, context and/or content information, layout/format information, and/or any other information to provide guidance to the LLM so that the LLM provides a response (e.g., determines a query) that meets the requirements/requests of the prompt. Step 216 can be performed manually to send/provide the encrypted information and/or query prompts to the LLM as performed by and/or initiated by a user/operator. Additionally and/or alternatively, step 216 can be performed automatically in response to, for example, the generation and/or reception of the query prompts and/or associated encrypted information. Step 216 can be performed automatically in response to any other triggering events/instructions. In another configuration, step 216 can include accessing, by the LLM, the query prompt and associated encrypted information at any location, such as in storage media 22 and/or 122.

Step 218 of process 200 can include generating, by the LLM, a query and/or output in response to the query prompt. Step 218 can be performed by an LLM and/or any system, model, etc. capable of generating the query and/or output in response to the query prompt (and the associated encrypted information). The LLM that can perform step 218 can be, for example LLM 16 and/or LLM 116 as described above, and the LLM can have any and/or all capabilities, functionalities, and/or configurations as LLMS 16 and/or 116. The query and/or output, as determined/generated in step 218, can be an “encrypted” query and/or output if the query and/or output is generated/determined by the LLM based upon a query prompt and/or associated information that is encrypted. Each query as generated/determined in step 218 can be, for example, instructions/requests that are understood by the graph database management system that, when performed on the graph database, returns a query response that satisfies the query (and/or the desired output). The queries, as determined by the LLM, can be in any format, configuration, etc. so as to be useful to the graph database management system and/or by a user/operator. The LLM can use the information provided along with the query prompt to generate/determine the query in the proper format, configuration, etc. Step 218 can be performed manually by the LLM to generate/determine the queries as initiated by a user/operator. Additionally and/or alternatively, step 218 can be performed automatically by the LLM in response to, for example, the access to and/or the reception of the query prompt and/or the associated information by the LLM. Moreover, step 218 can be performed automatically in response to any other triggering events/instructions. Step 218 can include allowing access to and/or providing the queries (as generated by the LLM) to and/or any of the components of systems 10 and/or 110, such as storage media 22/122 (to save the queries), user interface 24/124 (to allow a user/operator to view, interact with, and/or alter the queries), and/or replacement module 36 (for performance of step 220).

Next, process 200 can include step 220, which is replacing the keys in the encrypted query and/or encrypted output with the corresponding words to form an unencrypted query and/or unencrypted output. In other words, step 220 includes unencrypting the queries and/or outputs as generated/determined by the LLM. Step 220 can be performed by, for example, replacement module 36, any other components of systems 10 and/or 110, and/or any systems capable of replacing the keys with the corresponding words. Step 220 can include accessing, receiving, and/or otherwise using the encrypted outputs/prompts. Furthermore, step 220 can be performed and/or aided by referencing and/or otherwise using word-key pair database 40 to associate the keys with the corresponding words. Step 220 can be referred to as the collective replacement of any keys for each encrypted document that is to be unencrypted, so step 220 can be performed multiple times for multiple encrypted outputs/documents/information/prompts. Step 220 can include accessing and/or otherwise using word-key pair database 40 such that step 220 can be performed using/referring to word-key pair database 40 to replace one, multiple, or all keys that appear in word-key pair database 40 with the corresponding words that are associated with those keys in word-key pair database 40. Step 220 can be performed manually to replace the keys with the corresponding words as performed by and/or initiated by a user/operator. Additionally and/or alternatively, step 220 can be performed automatically in response to, for example, the accessing to and/or reception of the encrypted outputs/queries after being generated/determined by the LLM (e.g., the completion of step 218) and/or in response to, for example, any other triggering events/instructions. Step 220 can include saving the unencrypted queries and/or outputs, after the replacement of the keys with the words, at any location, including in storage media 22 and/or 122.

Process 200 can include step 222, which is, determining, based upon a graph database representative of the digital network, an unencrypted response to the unencrypted query. Step 222 can also include accessing, receiving, and/or otherwise using the unencrypted query and/or information as determined, for example, by the LLM and/or as unencrypted by, for example, replacement module 36. Step 222 can be performed by, for example, graph database management system 126, by any components of systems 10/110, and/or by any systems capable of determining a response to the query based upon the graph database that is representative of the digital network. Step 222 includes performing the query on the graph database to generate the requested results as requested/instructed in the query. In one example, the graph database management system is a Neo4j system and the query is a Cypher query. Thus, step 222 can include performing the Cypher query on the graph database to determine/generate the query response. The query response as determined/generated in step 222 can include any information as requested by the query and/or can be in any format, configuration, etc. The information, answers, results, etc. as determined/generated in step 222 in response to the query is referred to herein as a “query response” and can include, for example, network information 112C as set out in graph database 112B. In one example, the query can request, in a format that is common to graph databases, an explanation as to why device 1 failed to connect to device 2, both of which are on the digital network. Step 222 can determine, with reference to the graph database representative of the digital network, the answer/explanation in the form of a query response and in a format that is common to a graph database. This query response, in later steps (e.g., step 230), is then used to generate a natural language output to improve readability and/or understandability with the natural language output including the explanation as determined in step 222. Step 222 can be performed manually to determine a response to the query as performed by and/or initiated by a user/operator. Additionally and/or alternatively, step 222 can be performed automatically in response to, for example, the accessing to and/or reception of the encrypted and/or unencrypted outputs/queries after being generated/determined by the LLM (e.g., the completion of step 218) and/or after the unencryption of the queries/outputs (e.g., the completion of step 220). Moreover, step 222 can be performed automatically in response to, for example, any other triggering events/instructions. Step 222 can include saving the query responses and/or outputs at any location, including in storage media 22 and/or 122 and/or electronic storage internal to the graph database management system. Step 222 can also include allowing access to and/or providing the query response to the LLM and/or to any other components/systems, such as end users/systems 18/118.

Step 224 of process 200 can include replacing the words to be encrypted in the query response and/or associated unencrypted information with corresponding keys to form an encrypted query response (and/or associated encrypted information). Step 224 can be performed using the same word-key pair database 40 as used with regards to step 210, or step 224 can include reperforming steps 206, 208, 210, and/or 212 to identify new words to be encrypted, generate new keys corresponding to the words to be encrypted, replace those words with the corresponding keys, and save the new word-key pair database 40 and/or update the existing word-key pair database 40 with new words and/or new corresponding keys. Step 224 can be performed similarly to step 210 such that the words to be encrypted in the query responses and/or the associated unencrypted information have corresponding keys that preserve the format of the words as well as maintain referential integrity amongst encrypted words that appear multiple times in the query responses and/or associated information. Step 224 can be performed by, for example, replacement module 36 of system 10, any components of systems 10 and/or 110, and/or any other systems capable of encrypting the query responses and/or associated information while preserving format and maintaining referential integrity. Step 224 can be referred to as the collective replacement of any words to be encrypted for each unencrypted query response and/or associated information that is desired to be encrypted, so step 224 can be performed multiple times for multiple documents/information/queries responses. Step 224 can include accessing and/or otherwise using word-key pair database 40 such that step 224 is performed using/referring to word-key pair database 40 to replace one, multiple, or all words that appear in word-key pair database 40 with the corresponding keys. Step 224 can be performed manually to replace words to be encrypted with the corresponding keys as performed by and/or initiated by a user/operator. Additionally and/or alternatively, step 224 can be performed automatically in response to, for example, the completion of the determination/generation of queries responses (e.g., the completion of step 222) and/or any other triggering events/instructions. Step 224 can include saving the encrypted query responses and/or associated information to, for example, storage media 22/122 and/or at any other location.

Process 200 can include step 226, which is generating/determining one or multiple output prompts based on the encrypted query response(s) and/or associated encrypted information. The output prompts can be encrypted and/or unencrypted, and herein are described as being encrypted output prompts. Step 226 can be performed by, for example, prompt module 14 and/or 114 as detailed with regards to the systems/modules associated with encryption system 10 and network analysis system 110, respectively, and can be performed similarly to step 214, except that step 226 generates encrypted output prompts instead of query prompts. Additionally and/or alternatively, step 226 can be performed by any components of system 10/110 and/or any systems capable of generating/determining prompts (e.g., encrypted output prompts). The encrypted output prompt, as generated in step 226, can be, for example, a request to the LLM to generate/determine a natural language output dependent upon the encrypted query response(s) and/or the associated encrypted information. The query response can be, for example, in a format that is difficult for a user/operator to understand and/or read, so the output prompt, as generated/determine in step 226, can request that a natural language output restate, summarize, add to, and/or alter the query response to be more readable and/or understandable to a user/operator. As with step 214, step 226 can be performed manually to generate the encrypted output prompts as performed by and/or initiated by a user/operator, or step 226 can be automatically performed in response to, for example, the reception, generation, selection, etc. of the encrypted and/or unencrypted query responses and/or associated information. Step 226 can be performed automatically in response to any other triggering events/instructions. Step 226 can include saving the encrypted output prompts in storage media 22 and/or 122 and/or compiling the output prompt(s) with associated information (and/or other information, such as example descriptions that provide guidance as to content, layout, etc. of the natural language outputs) that is necessary for the LLM to determine a corresponding natural language output in response to the output prompt.

Process 200 can further include step 228, which is providing the encrypted output prompt(s), encrypted query responses, and/or any other necessary associated encrypted information to the LLM. Step 228 can be performed similarly to step 216 as described above. Step 228 can be performed by, for example, prompt modules 14 and/or 114, systems 10 and/or 110 generally, and/or via any wired and/or wireless communication. In one example, prompt modules 14/114 and/or systems 10/110 are in communication with the LLM, such as LLMs 16 and/or 116, via the internet. The encrypted query responses and/or any other necessary associated encrypted information as well as the encrypted output prompt(s) provided to the LLM can be any information that is necessary for the LLM to determine/generate the encrypted natural language output dependent upon the query response(s), which in turn depend upon the digital network as represented by, for example, the graph database. Thus, in one example, step 228 can include providing the encrypted output prompt(s) and any necessary associated encrypted information to the LLM but not providing the encrypted query response(s) (as determined/generated in step 222) in the situation when the encrypted query response(s) are not needed by the LLM to generate the natural language output(s). The associated encrypted information provided in step 228 can include any examples, context and/or content information, layout/format information, and/or any other information to provide guidance to the LLM so that the LLM provides a natural language output/response that meets the requirements/requests of the output prompt. Step 228 can be performed manually to send/provide the encrypted output prompts and/or associated encrypted information to the LLM as performed by and/or initiated by a user/operator. Additionally and/or alternatively, step 228 can be performed automatically in response to, for example, the generation and/or reception of the output prompts and/or associated encrypted information. Step 228 can be performed automatically in response to any other triggering events/instructions. In another configuration, step 228 can include accessing, by the LLM, the encrypted output prompt and associated encrypted information at any location, such as in storage media 22 and/or 122.

Step 230 of process 200 can include generating/determining, by the LLM, the encrypted natural language output. As described above, the natural language output can restate, summarize, add to, and/or alter the query response to be more readable and/or understandable to a user/operator. Further, step 230 can include generating/determining additional information to include in the natural language output based upon the query response and/or associated information Step 230 can be performed similarly to step 218 as described above. Step 230 can be performed by, for example, an LLM and/or any system, model, etc. capable of generating the natural language output in response to the output prompt (and the associated encrypted information, such as the query response). The LLM that can perform step 230 can be, for example LLM 16 and/or LLM 116 as described above, and the LLM can have any and/or all capabilities, functionalities, and/or configurations as LLMS 16 and/or 116. The natural language output, as determined/generated in step 230, can be an “encrypted” output if the output is generated/determined by the LLM based upon an output prompt and/or associated information (such as the query response) that is encrypted. Each natural language output as generated/determined in step 230 can, for example, restate, summarize, add to, and/or alter the query response to be more readable and/or understandable to a user/operator. The natural language output as determined/generated in step 230 can be in any format, configuration, etc. so as to be useful and/or understandable by an end user/operator, such as in natural language having sentences, paragraphs, lists, and/or other organizational methods. Step 230 can be performed manually by the LLM to generate/determine the encrypted natural language output as initiated by a user/operator. Additionally and/or alternatively, step 230 can be performed automatically by the LLM in response to, for example, the access to and/or the reception of the output prompt and/or the associated information (e.g., the query response) by the LLM. Moreover, step 230 can be performed automatically in response to any other triggering events/instructions. Step 230 can include allowing access to and/or providing the encrypted natural language output (as generated by the LLM) to and/or any of the components of) systems 10 and/or 110, such as storage media 22/122 (to save the encrypted natural language outputs), user interface 24/124 (to allow a user/operator to view, interact with, and/or alter the encrypted natural language outputs), and/or replacement module 36 (for performance of step 232).

Finally, process 200 can include step 232, which is replacing the keys in the encrypted natural language output with the corresponding words to form an unencrypted natural language output. Thus, step 232 can include unencrypting the encrypted natural language outputs as generated/determined by the LLM. Step 232 can be performed similarly to step 220 as described above. Step 232 can be performed by, for example, replacement module 36, any other components of systems 10 and/or 110, and/or any systems capable of replacing the keys with the corresponding words. Step 232 can include accessing, receiving, and/or otherwise using the encrypted natural language output. Furthermore, step 232 can be performed and/or aided by referencing and/or otherwise using word-key pair database 40 to associate the keys with the corresponding words. Step 232 can be referred to as the collective replacement of any keys for each encrypted natural language output that is to be unencrypted, so step 232 can be performed multiple times for multiple encrypted outputs/documents/information/prompts. Step 232 can include accessing and/or otherwise using word-key pair database 40 such that step 232 can be performed using/referring to word-key pair database 40 to replace one, multiple, or all keys that appear in word-key pair database 40 and the encrypted natural language output with the corresponding words that are associated with the keys in word-key pair database 40. Step 232 can be performed manually to replace the keys with the corresponding words as performed by and/or initiated by a user/operator. Additionally and/or alternatively, step 232 can be performed automatically in response to, for example, the accessing to and/or reception of the encrypted natural language outputs after being generated/determined by the LLM (e.g., the completion of step 230) and/or in response to, for example, any other triggering events/instructions. Step 232 can include saving the unencrypted natural language outputs, after the replacement of the keys with the corresponding words, at any location, including in storage media 22 and/or 122. Additionally, step 232 can include providing access to and/or sending the unencrypted natural language outputs to any location, including to an end user/system for review, further analysis, and/or modification.

Process 200 allows for any information that is provided to, accessed by, and/or otherwise used by the LLM to be encrypted. The encryption of the information preserves the format and maintains referential integrity of the encrypted information so that the LLM can use the encrypted information to make inferences and draw conclusions without the need to have access to the words, phrases, numbers, etc. that were encrypted. Additionally, process 200 allows for only the necessary information regarding the digital network and/or the graph database to be provided to, accessed by, and/or otherwise used by the LLM. This is because process 200 does not provide the entirety of the graph database to the LLM and instead has the LLM generate the query that is used on the graph database to answer the query/request (in the form of a query response). Then, process 200 provides the query response (and/or associated information as well as an output prompt) to the LLM for the LLM to form a natural language output explaining the query response. Such a process ensures that the graph database, which is based upon the digital network and can contain large amounts of sensitive/protected information, is not provided to the LLM and rather remains under the control/possession of the user/operator via, for example, systems 10 and/or 110.

### Discussion of Possible Embodiments

A method of encrypting information provided to a large language model can include receiving first unencrypted information; identifying a first word within the first unencrypted information that is to be encrypted; replacing the first word within the first unencrypted information with an automatically generated first key to create first encrypted information; automatically replacing all instances of the first word with the first key to maintain referential integrity amongst the first word and the first encrypted information; saving the first word and the associated first key in a first word-key pair database; providing the first encrypted information to the large language model along with a first prompt requesting that the large language model generate a first encrypted output dependent upon the first encrypted information; receiving, from the large language model, the first encrypted output dependent upon the first encrypted information; and replacing, using the first word-key pair database, all instances of the first key with the first word to create a first unencrypted output.

The method of the preceding paragraph can optionally include, additionally and/or alternatively, any one or more of the following features, configurations, steps, and/or components:

The method can include determining a second word within the first unencrypted information that is to be encrypted; replacing the second word within the first unencrypted information with an automatically generated second key such that the second word is not present in the first encrypted information; automatically replacing all instances of the second word in the first encrypted information with the second key; saving the second word and the associated second key in the first word-key pair database; and replacing, after the first encrypted output is received from the large language model, all instances of the second key in the first encrypted output with the second to form the first unencrypted output.

The method can include that the first unencrypted output is indicative of an inference dependent upon a digital network associated with the first unencrypted information.

The method can include generating, by the large language model, the first encrypted output dependent upon the first encrypted information.

The method can include that the step of identifying the first word within the first unencrypted information that is to be encrypted is performed by a computer processor using name recognition artificial intelligence software.

The method can include discarding the first word-key pair database after completion of all steps regarding the first unencrypted information.

The method can include receiving second unencrypted information that is at least partially different than the first unencrypted information; identifying at least a third word within the second unencrypted information that is to be encrypted; replacing all instances of the third word in the second unencrypted information with a third key to create second encrypted information; saving the third word and the associated third key to at least one of the first word-key pair database and a second word-key pair database; providing the second encrypted information and a second prompt to the large language model; receiving, from the large language model, a second encrypted output dependent upon the second encrypted information; and replacing all instances of the third key with the third word to create a second unencrypted output.

The method can include that the third word and the associated third key are saved to the second word-key pair database and further include discarding the second word-key pair database after completion of all steps regarding the second unencrypted information.

The method can include discarding the first word-key pair database after completion of all steps regarding the first unencrypted information and before the beginning of all steps regarding the second unencrypted information and saving the third word and the associated third key to the second word-key pair database.

The method can include, in response to the third word being the same as the first word, selecting the third key that is different from the first key.

The method can include discarding the first word-key pair database periodically after the completion of a communication session with the large language model and creating the second word-key pair database thereafter.

The method can include that the first word includes at least one of the following: a phrase, a proper noun, a numerical value, personally identifiable information, protected health information, financial records, human-resource data, commercial information, legal information, and controlled unclassified information.

The method can include that the first key maintains a similar format as the first word to preserve the format of the first word so that the first encrypted information maintains a similar context to the first unencrypted information.

The method can include that the first unencrypted output is a query.

The method can include providing the query to a graph database management system with access to a graph database representative of a digital network and performing the query, by the graph database management system, to determine an inference corresponding to the digital network, responsive to the query, and dependent upon the graph database.

A method of encrypting information provided to a large language model can include receiving unencrypted information; identifying at least one word to be encrypted; for each word of the at least one word to be encrypted, automatically generating a corresponding key; replacing each word of the at least one word to be encrypted with the corresponding key to form encrypted information, wherein each key maintains a similar format as each corresponding word to preserve the format of the word so that the encrypted information maintains a similar context to the unencrypted information; saving each different word that is encrypted and each corresponding key in a word-key pair database; providing the encrypted information and a prompt to the large language model; receiving, from the large language model, an encrypted output dependent upon the encrypted information; and replacing each key corresponding to each word of the at least one word in the encrypted output to form an unencrypted output.

The method of the preceding paragraph can optionally include, additionally and/or alternatively, any one or more of the following features, configurations, steps, and/or components:

The method can include that the unencrypted output is indicative of an inference dependent upon a digital network associated with the unencrypted information.

The method can include that the at least one word is at least one of the following: a phrase, a proper noun, a numerical value, personally identifiable information, protected health information, financial records, human-resource data, commercial information, legal information, and controlled unclassified information.

The method can include replacing all instances of the word to be encrypted with the same corresponding key to retain referential integrity amongst the encrypted words in the encrypted information.

A system for encrypting information for use with a large language model can include unencrypted information that can include at least one word to be encrypted; an identification module configured to identify the at least one word to be encrypted in the unencrypted information; a key generation module configured to generate at least one key corresponding to the at least one word to be encrypted in the unencrypted information, the at least one key having a similar format as the corresponding at least one word so that the key preserves the format of the corresponding word to maintain a similar context; a word-key pair database that includes the at least one word to be encrypted and the corresponding at least one key; a replacement module configured to replace the at least one word with the corresponding at least one key, wherein the replacement module replaces all instances of the at least one word with the corresponding at least one key to form encrypted information; a prompt module configured to determine a prompt to the large language model requesting the large language model to determine an encrypted output based upon the encrypted information; and wherein, in response to the reception of the encrypted output from the large language model, the replacement module is configured to replace the at least one key with the corresponding at least one word to form an unencrypted output.

The system of the preceding paragraph can optionally include, additionally and/or alternatively, any one or more of the following features, configurations, steps, and/or components:

The system can include storage media within which the word-key pair database is stored.

The system can include that the identification module includes a first computer processor that is configured to use name recognition artificial intelligence software to determine multiple words that are to be encrypted.

The system can include that the at least one word to be encrypted includes at least one of the following: a phrase, a proper noun, a numerical value, personally identifiable information, protected health information, financial records, human-resource data, commercial information, legal information, and controlled unclassified information.

The system can include that the large language model is configured to determine the encrypted output as requested by the prompt module and based upon the encrypted information.

The system can include that the replacement module is in communication with the large language model via the internet.

The system can include that the key generation module includes a second computer processor that is configured to analyze the format of the at least one word and generate the at least one key having a similar format as the corresponding at least one word.

The system can include that the unencrypted output is indicative of an inference dependent upon a digital network.

The system can include that the unencrypted output is a conclusion detailing why one device of the digital network failed to connect to another device of the digital network.

The system can include that the word-key pair database is discarded after the replacement module forms the unencrypted output.

The system can include a new word-key pair database corresponding to new unencrypted information.

The system can include that the at least one word to be encrypted includes a first word that appears multiple times in the unencrypted information and a second word that is different from the first word.

The system can include a user interface configured to allow for viewing of the unencrypted information, the encrypted information, the word-key pair database, the encrypted output, or the unencrypted output.

The system can include a graph database management system in communication with a graph database that includes at least a portion of the unencrypted information.

The system can include that the unencrypted output is a query that is communicated to the graph database management system and the graph database management system is configured to use the query to determine a conclusion based upon the graph database.

A system for encrypting information for use with a large language model can include an identification module configured to identify, in unencrypted information, a word to be encrypted; a key generation module configured to generate a key corresponding to the word to be encrypted in the unencrypted information; a replacement module configured to replace all instances of the word with the corresponding key to form encrypted information, the replacement module replacing all instances of the word in the unencrypted information with the same corresponding key to maintain referential integrity amongst the newly formed encrypted information; and a prompt module configured to generate a prompt to the large language model requesting the large language model to generate an encrypted output based upon the encrypted information that includes the key, wherein, in response to the reception of the encrypted output from the large language model, the replacement module is configured to unencrypt the encrypted output to form an unencrypted output by replacing all instances of the key in the encrypted output with the corresponding word.

The system of the preceding paragraph can optionally include, additionally and/or alternatively, any one or more of the following features, configurations, steps, and/or components:

The system can include a word-key pair database to which the word to be encrypted and the corresponding key are saved for later use by the replacement module to form the unencrypted output.

The system can include that the key generation module includes a computer processor configured to analyze a format of the word to be encrypted and generate the key that has a similar format to the corresponding word.

The system can include that the identification module is configured to use name recognition artificial intelligence software to determine the word to be encrypted.

The system can include that the word to be encrypted includes at least one of the following: a phrase, a proper noun, a numerical value, personally identifiable information, protected health information, financial records, human-resource data, commercial information, legal information, and controlled unclassified information.

A method of determining a natural language output regarding a digital network using a large language model can include formulating a desired output dependent upon information associated with the digital network; providing, to the large language model, the information associated with the digital network and a first prompt requesting the large language model to generate a query dependent upon the information and the desired output; receiving, from the large language model, the query dependent upon the information and the desired output; determining, dependent upon a graph database, a response to the query with the graph database being representative of at least a portion of the digital network; providing, to the large language model, the response and a second prompt requesting the large language model to generate the natural language output dependent upon the response; and receiving, from the large language model, the natural language output dependent upon the response and associated with the digital network.

The method of the preceding paragraph can optionally include, additionally and/or alternatively, any one or more of the following features, configurations, steps, and/or components:

The method can include that the desired output is at least one of the following: an explanation as to why one device on the digital network failed to connect to another device on the digital network; an analysis as to how the digital network responds to an outage of at least one specified device; and an answer to an inquiry asking how many devices and the names of those devices that are connected to a first device on the digital network.

The method can include that the natural language output is indicative of an outcome of an event affecting the digital network as represented by the graph database.

The method can include that the query includes at least a portion of the information associated with the digital network.

The method can include, before providing the information to the large language model, identifying multiple words in the information associated with the digital network that are to be encrypted; replacing each word of the multiple words that are to be encrypted with a corresponding key to form encrypted information; and providing the encrypted information, in place of the unencrypted information, to the large language model along with the first prompt.

The method can include that the step of identifying multiple words that are to be encrypted is performed by a computer processor using name recognition artificial intelligence software.

The method can include that each key that replaces each corresponding word to be encrypted maintains a similar format to the corresponding word so that the encrypted information maintains a similar context to the unencrypted information.

The method can include that a first key that replaces a corresponding first word has the same number of characters as the first word.

The method can include that the query as received from the large language model dependent upon the encrypted information includes at least one key.

The method can include, after receiving the query from the large language model, replacing each key with each corresponding word of the multiple corresponding words to unencrypt the query.

The method can include, before providing the response to the query to the large language model, again identifying multiple words in the response that are to be encrypted; replacing each word of the multiple words that are to be encrypted with the corresponding key to form an encrypted response; and providing the encrypted response, in place of the unencrypted response, to the large language model along with the second prompt.

The method can include that the same word of the multiple words that are to be encrypted in the information as well as in the response are replaced by the same key so as to maintain referential integrity.

The method can include saving each word of the multiple words that are to be encrypted along with the corresponding key used in both the information and the response in a word-key pair database.

The method can include generating, by the large language model, the natural language output dependent upon the response.

The method can include that the graph database is stored at a location distant from the large language model.

The method can include that the graph database is stored at a location that is at least partially under the control of a user such that the graph database is not provided to the large language model.

The method can include that the step of determining the response to the query is performed by a graph database management system with access to the graph database.

The method can include that the graph database management system is a Neo4j system.

The method can include that the query is a Cypher query and the graph database management system is configured to receive the Cypher query and generate a response to the Cypher query dependent upon the graph database.

The method can include that the step of determining the response to the query is performed automatically by the graph database management system in response to the reception of the query.

A system for determining a natural language output regarding a digital network using a large language model can include a computer processor configured to receive a desired output dependent upon information associated with the digital network; a prompt module configured to determine a query prompt to the large language model requesting the large language model to generate a query dependent upon the information and the desired output; and a graph database management system configured to determine, dependent upon a graph database representative of at least a portion of the digital network, a response to the query as received from the large language model, wherein the prompt module is also configured to determine an output prompt to the large language model requesting the large language model to generate the natural language output dependent upon the response to the query, and wherein the large language model generates the natural language output as requested in the output prompt.

The system of the preceding paragraph can optionally include, additionally and/or alternatively, any one or more of the following features, configurations, steps, and/or components:

The system can include that the large language model configured to generate the natural language output as requested by the prompt module and dependent upon the response to the query.

The system can include that the prompt module is in communication with the large language model via the internet.

The system can include a user interface configured to allow for the determination of the desired output dependent upon information associated with the digital network.

The system can include that the user interface allows for the selection of the desired output from a predefined list.

The system can include that the output prompt and the response to the query are provided to the large language model.

The system can include that the output prompt and information dependent upon the response to the query are provided to the large language model and the response to the query is not provided directly to the large language model.

The system can include that the query prompt and the output prompt as determined by the prompt module are different from one another.

The system can include that the desired output is at least one of the following: an explanation as to why one device on the digital network failed to connect to another device on the digital network; an analysis as to how the digital network responds to an outage of at least one specified device; and an answer to an inquiry asking how many devices and the names of those devices that are connected to a first device on the digital network.

The system can include that the natural language output as generated by the large language model is indicative of an outcome of an event affecting the digital network as represented by the graph database.

The system can include that the query as received from the large language model is a Cypher query.

The system can include that the graph database management system is a Neo4j system that is configured to receive the Cypher query and generate a response to the Cypher query dependent upon the graph database.

The system can include storage media within which the graph database is stored, and wherein the graph database management system is in communication with the storage media to access the graph database.

The system can include that the graph database is stored at a location that is at least partially under the control of a user such that the graph database is not provided to the large language model.

The system can include that the graph database management system is configured to determine the response to the query automatically in response to the reception of the query.

A system for determining a natural language output regarding a digital network can include a computer processor configured to receive a desired output as selected by a user, the desired output being dependent upon information associated with the digital network; a prompt module in communication with the computer processor and configured to generate a query prompt to a large language model; the large language model configured to generate a query dependent upon the information and the query prompt; a graph database management system configured to determine, dependent upon a graph database representative of at least a portion of the digital network, a response to the query as generated by the large language model, wherein the prompt module is configured to generate an output prompt dependent upon the response to the query, and wherein the large language model, in response to the output prompt, generates a natural language output dependent upon the response to the query as determined by the graph database management system.

The system of the preceding paragraph can optionally include, additionally and/or alternatively, any one or more of the following features, configurations, steps, and/or components:

The system can include that the large language model is separate and distinct from the computer processor and communicates with the prompt module via the internet.

The system can include that the graph database is stored at a location that is at least partially under the control of the user such that the graph database is not provided to the large language model.

The system can include that the query as generated by the large language model is a Cypher query and the graph database management system is a Neo4j system configured to use the Cypher query.

The system can include that the digital network includes multiple interconnected devices with those devices and the interconnectivity of those devices being represented by information within the graph database.

A method for determining a natural language output regarding a digital network using encryption with a large language model can include receiving unencrypted information that includes a desired output dependent upon the digital network; identifying at least one word within the unencrypted information that is to be encrypted; generating a corresponding key for each word of the at least one word to be encrypted; replacing each instance of the at least one word in the unencrypted information with the corresponding key to form first encrypted information; providing, to the large language model, the first encrypted information that is associated with the digital network and a query prompt requesting the large language model to generate an encrypted query dependent upon the first encrypted information; receiving, from the large language model, the encrypted query as requested by the query prompt and dependent upon the first encrypted information; replacing each instance of the at least one key in the encrypted query with the corresponding word of the at least one word to form an unencrypted query; determining, dependent upon a graph database, an unencrypted response to the unencrypted query with the graph database being representative of at least a portion of the digital network; replacing each instance of the at least one word in the unencrypted response with the corresponding key to form an encrypted query response; providing, to the large language model, second encrypted information dependent upon the encrypted query response and an output prompt requesting the large language model to generate an encrypted natural language output dependent upon the second encrypted information; receiving, from the large language model, the encrypted natural language as requested by the output prompt and dependent upon the second encrypted information; and replacing each instance of the at least one key in the encrypted natural language output with the corresponding key to form an unencrypted natural language output regarding the digital network.

The method of the preceding paragraph can optionally include, additionally and/or alternatively, any one or more of the following features, configurations, steps, and/or components:

The method can include replacing each instance of the at least one word in the query prompt with the corresponding key to form an encrypted query prompt, wherein the encrypted query prompt is provided to the large language model and the large language model generates the encrypted query as requested by the encrypted query prompt.

The method can include replacing each instance of the at least one word in the output prompt with the corresponding key to form an encrypted output prompt, wherein the encrypted output prompt is provided to the large language model and the large language model generates the encrypted natural language output as requested by the encrypted output prompt.

The method can include that the step of generating the corresponding key for each word of the at least one word to be encrypted further includes analyzing a format of each word of the at least one word to be encrypted and generating each key having a similar format to the corresponding word to be encrypted to preserve the format of the word so that the first encrypted information maintains a similar context to the unencrypted information.

The method can include saving the at least one word to be encrypted and each corresponding key in a word-key pair database.

The method can include that the steps requiring the replacement of the at least one word to be encrypted with the corresponding key or the replacement of the at least one key with the corresponding word is performed by using the word-key pair database.

The method can include that the unencrypted natural language output is indicative of an inference dependent upon the digital network.

The method can include that the desired output is at least one of the following: an explanation as to why one device on the digital network failed to connect to another device on the digital network; an analysis as to how the digital network responds to an outage of at least one specified device; and an answer to an inquiry asking how many devices and the names of those devices that are connected to a first device on the digital network.

The method can include that the graph database is stored at a location distant from the large language model and the graph database is not provided to the large language model.

The method can include that the step of determining the unencrypted response to the unencrypted query dependent upon the graph database is performed by a graph database management system with access to the graph database.

A system for determining a natural language output regarding a digital network using encryption with a large language model can include an identification module configured to identify, in unencrypted information that includes a desired output associated with the digital network, at least one word to be encrypted; a key generation module configured to generate a key corresponding to each word of the at least one word to be encrypted; a replacement module configured to replace all instances of each word of the at least one word to be encrypted with each corresponding key to form first encrypted information; a prompt module configured to generate a query prompt requesting the large language model to generate an encrypted query dependent upon the first encrypted information, wherein the encrypted query is unencrypted by the replacement module to form an unencrypted query; a graph database management system configured to determine, dependent upon a graph database representative of the digital network, an unencrypted query response based upon the unencrypted query, wherein the prompt module is configured to generate an output prompt requesting the large language model to generate an encrypted natural language output dependent upon second encrypted information based upon the unencrypted query response and encrypted by the replacement module, and wherein the replacement module is configured to unencrypted the encrypted natural language output as received from the large language model to form an unencrypted natural language output associated with the digital network.

The system of the preceding paragraph can optionally include, additionally and/or alternatively, any one or more of the following features, configurations, steps, and/or components:

The system can include storage media within which the graph database is stored, and wherein the graph database management system is in communication with the storage media to access the graph database.

The system can include that the large language model is configured to generate the encrypted query in response to the query prompt and generate the encrypted natural language output in response to the output prompt.

The system can include that the graph database is stored at a location distant from the large language model.

The system can include that the encrypted query as received from the large language model is a Cypher query.

The system can include that the graph database management system is a Neo4j system and is configured to generate the unencrypted query response dependent upon the Cypher query.

The system can include that the graph database management system is configured to determine the unencrypted query response automatically in response to the reception of the unencrypted query.

The system can include a user interface configured to allow for the determination of the desired output dependent upon information associated with the digital network.

The system can include a word-key pair database to which the at least one word to be encrypted and the corresponding first key are saved for later use by the replacement module.

The system can include that the at least one word to be encrypted includes at least one of the following: a phrase, a proper noun, a numerical value, personally identifiable information, protected health information, financial records, human-resource data, commercial information, legal information, and controlled unclassified information.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method for determining a natural language output regarding a digital network using encryption with a large language model, the method comprising:
receiving unencrypted information that includes a desired output dependent upon the digital network;
identifying at least one word within the unencrypted information that is to be encrypted;
generating a corresponding key for each word of the at least one word to be encrypted;
replacing each instance of the at least one word in the unencrypted information with the corresponding key to form first encrypted information;
providing, to the large language model, the first encrypted information that is associated with the digital network and a query prompt requesting the large language model to generate an encrypted query dependent upon the first encrypted information;
receiving, from the large language model, the encrypted query as requested by the query prompt and dependent upon the first encrypted information;
replacing each instance of the at least one key in the encrypted query with the corresponding word of the at least one word to form an unencrypted query;
determining, dependent upon a graph database, an unencrypted response to the unencrypted query with the graph database being representative of at least a portion of the digital network;
replacing each instance of the at least one word in the unencrypted response with the corresponding key to form an encrypted query response;
providing, to the large language model, second encrypted information dependent upon the encrypted query response and an output prompt requesting the large language model to generate an encrypted natural language output dependent upon the second encrypted information;
receiving, from the large language model, the encrypted natural language output as requested by the output prompt and dependent upon the second encrypted information; and
replacing each instance of the at least one key in the encrypted natural language output with the corresponding key to form an unencrypted natural language output regarding the digital network.

2. The method of claim 1, further comprising:
replacing each instance of the at least one word in the query prompt with the corresponding key to form an encrypted query prompt,
wherein the encrypted query prompt is provided to the large language model and the large language model generates the encrypted query as requested by the encrypted query prompt.

3. The method of claim 1, further comprising:
replacing each instance of the at least one word in the output prompt with the corresponding key to form an encrypted output prompt,
wherein the encrypted output prompt is provided to the large language model and the large language model generates the encrypted natural language output as requested by the encrypted output prompt.

4. The method of claim 1, wherein the step of generating the corresponding key for each word of the at least one word to be encrypted further comprising:
analyzing a format of each word of the at least one word to be encrypted; and
generating each key having a similar format to the corresponding word to be encrypted to preserve the format of the word so that the first encrypted information maintains a similar context to the unencrypted information.

5. The method of claim 1, further comprising:
saving the at least one word to be encrypted and each corresponding key in a word-key pair database.

6. The method of claim 5, wherein the steps requiring the replacement of the at least one word to be encrypted with the corresponding key or the replacement of the at least one key with the corresponding word is performed by using the word-key pair database.

7. The method of claim 1, wherein the unencrypted natural language output is indicative of an inference dependent upon the digital network.

8. The method of claim 1, wherein the desired output is at least one of the following: an explanation as to why one device on the digital network failed to connect to another device on the digital network; an analysis as to how the digital network responds to an outage of at least one specified device; and an answer to an inquiry asking how many devices and the names of those devices that are connected to a first device on the digital network.

9. The method of claim 1, wherein the graph database is stored at a location distant from the large language model and the graph database is not provided to the large language model.

10. The method of claim 1, wherein the step of determining the unencrypted response to the unencrypted query dependent upon the graph database is performed by a graph database management system with access to the graph database.

11. A system for determining a natural language output regarding a digital network using encryption with a large language model, the system comprising:
an identification module configured to identify, in unencrypted information that includes a desired output associated with the digital network, at least one word to be encrypted;
a key generation module configured to generate a key corresponding to each word of the at least one word to be encrypted;
a replacement module configured to replace all instances of each word of the at least one word to be encrypted with each corresponding key to form first encrypted information;
a prompt module configured to generate a query prompt requesting the large language model to generate an encrypted query dependent upon the first encrypted information, wherein the encrypted query is unencrypted by the replacement module to form an unencrypted query;
a graph database management system configured to determine, dependent upon a graph database representative of the digital network, an unencrypted query response based upon the unencrypted query,
wherein the prompt module is configured to generate an output prompt requesting the large language model to generate an encrypted natural language output dependent upon second encrypted information based upon the unencrypted query response and encrypted by the replacement module, and
wherein the replacement module is configured to unencrypted the encrypted natural language output as received from the large language model to form an unencrypted natural language output associated with the digital network.

12. The system of claim 11, further comprising:
storage media within which the graph database is stored, and
wherein the graph database management system is in communication with the storage media to access the graph database.

13. The system of claim 11, further comprising:
the large language model configured to generate the encrypted query in response to the query prompt and generate the encrypted natural language output in response to the output prompt.

14. The system of claim 13, wherein the graph database is stored at a location distant from the large language model.

15. The system of claim 11, wherein the encrypted query as received from the large language model is a Cypher query.

16. The system of claim 15, wherein the graph database management system is a Neo4j system and is configured to generate the unencrypted query response dependent upon the Cypher query.

17. The system of claim 11, wherein the graph database management system is configured to determine the unencrypted query response automatically in response to the reception of the unencrypted query.

18. The system of claim 11, further comprising:
a user interface configured to allow for the determination of the desired output dependent upon information associated with the digital network.

19. The system of claim 11, further comprising:
a word-key pair database to which the at least one word to be encrypted and the corresponding first key are saved for later use by the replacement module.

20. The system of claim 11, wherein the at least one word to be encrypted includes at least one of the following: a phrase, a proper noun, a numerical value, personally identifiable information, protected health information, financial records, human-resource data, commercial information, legal information, and controlled unclassified information.
